(19) United States
(12) Patent Application Publication
(10) Pub. No.: US 2005/0158500 A1
(43) Pub. Date: Jul. 21, 2005

(54) Photo-curable adhesive sheet, photo-curable transfer sheet, optical information recording medium, and method for preparing optical information recording medium

(76) Inventors: Hideki Kitano, Tokyo (JP); Hidefumi Kotsubo, Tokyo (JP); Takato Inamiya, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/507,320

(22) PCT Filed: Mar. 10, 2003
(86) PCT No.: PCT/JP03/02786

(30) Foreign Application Priority Data
Mar. 13, 2002 (JP) 2002-68552
Mar. 14, 2002 (JP) 2002-70540
Mar. 22, 2002 (JP) 2002-81616

(51) Int. Cl. B32B 9/00

(52) U.S. Cl. 428/40.1

(57) ABSTRACT

A process for the preparation of an optical information recording medium comprises superposing two optical information recording substrates having an uneven surface of recorded pits and/or grooves on each other through a photo-curable adhesive sheet comprising a photo-curable composition which comprises a reactive polymer having a photopolymerizable functional group and Tg of not more than 20° C., the photo-curable adhesive sheet having a light transmittance of not less than 70% in a wavelength range of 380 to 420 nm, such that the two uneven surfaces face each other, depressing the substrates and sheet to form a laminate, and curing the laminate by light. A process for the preparation of an optical information recording medium comprises placing a photo-curable transfer sheet comprising a photo-curable composition which comprises a reactive polymer having a photopolymerizable functional group and Tg of not more than 20° C. on an optical information recording substrate having an uneven surface of recorded pits and/or grooves such that one side of the photo-curable transfer sheet is in contact with the uneven surface of the optical information recording substrate, depressing the sheet and substrate to form a laminate in which the one side of the photo-curable transfer sheet adheres closely to the uneven surface, and exposing the photo-curable transfer sheet of the laminate to ultraviolet rays to cure the transfer sheet. A photo-curable transfer sheet comprises a photo-curable composition which comprises a reactive polymer having a photopolymerizable functional group and which is capable of deforming by application of pressure, at least one side of the photo-curable transfer sheet having a surface roughness (Ra) of not more than 30 nm.

### BACKGROUND OF INVENTION

1. Field of the Invention

The present invention relates to an optical information recording medium, such as DVD (Digital Versatile Disc), CD (Compact Disc), an optical magnetic disc or a hard disc, in which a large amount of information such as letters, sound and animation is recorded and/or recordable as digital signals, and a process for the preparation thereof, and further a photo-curable adhesive sheet and a photo-curable transfer sheet in the preparation of the medium.

2. Description of the Related Art

As an optical information recording medium in which digital signals have been already recorded by forming pits on its surface, CD and CD-ROM are widely used. Recently, DVD that animation can be also recorded by forming pits on its both (double) sides has been noted as the next generation recording medium instead of CD and increasingly used. Further, attention is directed to recordable discs such as CD-R, DVD-R and DVD-RW having groove(s) or grooves and pits thereon. Furthermore, an optical magnetic disc and a hard disc are also well known as the recordable disc.

Conventional DVD having recording layers on its both sides includes a disc readable from double sides, as shown in, for example, FIG. 12, in which each of reflective layers 1a, 2a is formed on a surface of signal-pits of each of transparent resin substrates 1, 2 having the surface of signal-pits on its one side, and the two transparent resin substrates 1, 2 are bonded to each other through an adhesive layer 3 such that the reflective layers 1a, 2a face each other; and a disc readable from single side, as shown in, for example, FIG. 13, in which a semitransparent reflective layers 1b is formed on a surface of signal-pits of one transparent resin substrate 1 while a reflective layers 2a is formed on a surface of signal-pits of another transparent resin substrate 2 and the two transparent resin substrates 1, 2 are bonded to each other through an adhesive layer 3 such that the semitransparent reflective layers 1b and the reflective layer 2a face each other.

The DVD readable from double sides can be prepared, for example, by subjecting melted polycarbonate resin to injection molding by the use of a stamper having unevenness (concave and convex) corresponding to the reverse of unevenness of the signal-pit to be recorded on the substrate to prepare a transparent resin substrate having unevenness on its surface, forming a reflective layer on the uneven surface by spattering metal such as aluminum on it, and bonding two transparent resin substrates obtained in the above manner to each other through an adhesive such that the two reflective layers face each other. The adhesive usually uses an ultraviolet (UV) curable resin in the form of liquid.

The preparation of the optical information recording medium such as DVD usually requires an adhesive step for bonding two transparent resin substrates as mentioned above. Since the optical information recording medium is recorded and read out by light, a substrate of the medium is needed to have a uniform thickness and high transparency, and be free from deformation such as warpage. When the liquid UV curable resin is used as an adhesive, the resultant adhesive layer has high transparency but is apt to have warpage due to large shrinkage on curing, which possibly results on reduction of dimensional stability.

JA11-273147 describes that a pressure-sensitive adhesive sheet or a dry photopolymer in addition to the liquid UV curable resin is used for bonding a transparent film to an injection molded substrate having an uneven surface. However, the publication describes that the dry photopolymer is not preferred due to its low transparency.

With increase of information to be recorded, a new optical information recording medium, which has lager storage capacity than DVD now on use, is proposed. To obtain the large storage capacity, it is required to not only reduce sizes of signal pits and a groove but also shorten a wavelength of recording or reading laser. Further the shortening of the wavelength reduces distance between the laser and a surface having the pits and therefore it is needed to reduce a thickness of the optical recording substrate. Hence, it is also preferred to reduce a thickness of the adhesive layer.

For example, a standardized specification of a next generation optical disc “Blue-Ray Disc” was proposed on Feb. 10, 2002. The specification mainly includes storage capacity of 23.3/25/27 GB, laser wavelength of 405 nm (violaceous laser), lens numerical aperture (N/A) of 0.85, disc diameter of 120 mm, disc thickness of 1.2 mm and track pitch of 0.32 μm.

In the Blue-Ray Disc, as mentioned above, the sizes of groove and pits are reduced, and therefore it is required to reduce a spot size of a reading laser. The reduction of the spot size results in that the reading is apt to be influenced by inclination of the disc, and hence even DVD having a little warpage cannot be reproduced (read out). In order to avoid the disadvantage, it may be effective to reduce a thickness of a substrate and make a thickness of a cover layer provided on pits surface on a laser-irradiation side to approx. 0.1 mm.

“NIKKEI ELECTRONICS, Nov.” 5, 2001, pp. 68 describes a process for the preparation of DVD suited to the above-mentioned requirements. The procerss is explained by referring to FIG. 14. A UV curable resin 5A is provided, by application, on a reflective layer (or recording layer) 6a of a disc substrate (0.1 mm) 4a having the reflective layer on its uneven surface, while a UV curable resin 5B is provided, by application, on a stamper 4b made of polycarbonate having uneven surface. Subsequently, after the substrate is turned over, the turned-over substrate and the stamper are put together, and the UV curable resins 5A, 5B are cured by irradiating ultraviolet beam from the stamper side. The stamper 4b is then removed from the cured UV curable resin 5B, a reflective layer (or recording layer) 6b is formed on the uneven surface and further a cover layer (thickness of approx. 0.1 mm) 7 is provided the reflective layer 6b.

### SUMMARY OF THE INVENTION

To achieve a new optical information recording medium having lager storage capacity than DVD now on use, the present inventors have made an enthusiastic study. A first aspect according to the present invention is made in view of the disadvantage of the above-mentioned adhesive, and hence the object of the first invention is to provide a photo curable adhesive sheet that can be advantageously used in the preparation of an optical information recording medium.

Further, the object of the first aspect is to provide a photo curable adhesive sheet that can be advantageously used in the preparation of an optical information recording medium having good dimensional stability and high transparency.

Furthermore, the object of the first aspect is to provide a process for the preparation of an optical information recording medium by using the photo curable adhesive sheet.

In the process described in NIKKEI ELECTRONICS, a UV curable resin (layer) is provided on a disc substrate and a stamper by application, and the substrate is turned over and bonded to the stumper. Hence, the process is needed to perform complicated procedures such as the application and turning over steps. In more detail, when the turned-over substrate and the stamper are put together through UV curable resins, bubbles are generated in the vicinity of an interface of the combined UV curable resins. Hence it is difficult to successfully bond the UV curable resins of the substrate and stamper to each other. Furthermore, the UV curable resin is accompanied by large shrinkage on its curing, and hence the resultant medium is apt to have deformation such as warpage.

In view of the above-mentioned problems, the object of a second aspect of the invention is to provide a process for preparing extremely easily an optical information recording medium in high productivity, which is useful for forming on a disc substrate having an uneven surface a layer having an uneven surface (i.e., another uneven surface).

Further, the object of a second aspect of the invention is to provide a process for the preparation of an optical information recording medium which is capable of transferring easily and precisely an uneven surface of a disc substrate.

Furthermore, the object of a second aspect of the invention is to provide a process for the preparation of an optical information recording medium which is capable of transferring successively, easily and precisely an uneven surface of a disc substrate and an uneven surface of a stamper.

Moreover, the object of a second aspect of the invention is to provide an optical information recording medium scarcely having deformation such as warpage which can be obtained by the above-mentioned process.

Further, the object of a second aspect of the invention is to provide an optical information recording medium having precisely transferred unevenness and excellent smooth surface, especially an optical information recording medium having a reduced thickness.

As mentioned above, though a transparent resin substrate (optical information recording substrate) of DVD is prepared by injection molding of polycarbonate, the formation of pits by the injection molding brings about reduction of precision of pit shape transferred from the stamper to the polycarbonate resin, particularly in case of a substrate having thickness of 300 μm or less (see JA11-273147). Further, the present inventors have found a problem that a land portion of the surface having the pits comes to rough.

The present applicant filled a patent application as to a photo-curable transfer sheet having a little shrinkage on curing to which an unevenness surface of a stamper for preparing a substrate of an optical information recording medium can be easily and precisely transferred by depression, and especially by which a thin substrate having thickness of 300 μm or less can be advantageously prepared (Patent Application No. 2001-305946). The sheet is used in the above-mentioned process. Though this sheet has a little shrinkage on curing, it does not occasionally have sufficiently excellent smooth surface. In more detail, a surface having no unevenness of the substrate corresponds to a side irradiated by a laser for recording and/or reading out, and therefore when the surface is rough, errors are apt to occur in the operation for recording and/or reading out.

In view of the above-mentioned problems, the object of a third aspect of the invention is to provide a photo-curable transfer sheet having sufficiently an excellent smooth surface to which an uneven surface of a stamper for preparing a substrate of an optical information recording medium can be easily and precisely transferred by depression, and especially by which a thin substrate having thickness of 300 μm or less can be advantageously prepared.

Further, the object of a third aspect of the invention is to provide a process for the preparation of the above-mentioned photo-curable transfer sheet.

Furthermore, the object of a third aspect of the invention is to provide a photo-curable transfer sheet suitable for preparing an optical information recording medium having one surface onto which unevenness of a stamper is precisely transferred and the other surface having excellent smoothness (laser-irradiation side).

Moreover, the object of a third aspect of the invention is to provide a photo-curable transfer sheet suitable for preparing an optical information recording medium having precisely formed pit signals and/or groove on one side (surface) and excellent smoothness on the other side (laser-irradiation side).

In the first to third aspects of the present invention, it is common to realize a new optical information recording medium having lager storage capacity than DVD is common, and particularly common is the use of a specific photo-curable composition comprising a reactive polymer having a photopolymerizable functional group.

The first aspect is attained by a photo-curable adhesive sheet comprising a photo-curable composition which comprises a reactive polymer having a photopolymerizable functional group and weight-average molecular weight of not less than 5,000 and which has a glass transition temperature of not more than 20° C., the photo-curable adhesive sheet having a light transmittance of not less than 70% in a wavelength range of 380 to 420 nm.

In the photo-curable adhesive sheet, the reactive polymer preferably has a glass transition temperature of not more than 20° C., which renders the formation of unevenness by depression at room temperature easy. The photo-curable adhesive sheet preferably has a light transmittance of not less than 80% in a wavelength rang of 380 to 420 nm. Further, the adhesive sheet preferably has a light transmittance of not less than 70% in a wavelength rang of 380 to 600 nm, especially in a wavelength rang of 380 to 800 nm. It is ensured that an optical disc (optical information recording medium) obtained by using the adhesive sheet having the light transmittance is read out without error if the disc is done by irradiation of laser. Moreover, the photo-curable adhesive sheet generally has cure shrinkage of not more than 8%.

Further, it is preferred that the reactive polymer is an acrylic resin. Further the reactive polymer preferably has 1 to 50% by mole of the photopolymerizable functional group. The photopolymerizable functional group generally is a (meth)acryloyl group. The preferred reactive polymer is an acrylic resin having the photopolymerizable functional group through a urethane bond. The photo-curable composition generally contains 0.1 to 10% by weight of a photopolymerization initiator. The photo-curable adhesive sheet preferably has a thickness of 5 to 300 μm. It is preferred that a release sheet is provided on at least (especially both sides) one side of the photo-curable adhesive sheet.

The first aspect of the invention is also provided by a process for the preparation of an optical information recording medium comprising:
superposing two optical information recording substrates having an uneven surface of recorded pits and/or grooves on each other through the photo-curable adhesive sheet as defined in any of claims 1 to 9 such that the two uneven surfaces face each other,
depressing the substrates and sheet to form a laminate, and curing the laminate by light.

In the process, the depressing step is preferably carried out under reduced pressure, and the depressing step is also preferably carried out at room temperature.

The second aspect of the invention is provided by a process for the preparation of an optical information recording medium comprising:
placing a photo-curable transfer sheet comprising a photo-curable composition which comprises a reactive polymer having a photopolymerizable functional group and weight-average molecular weight of not less than 5,000 and which is capable of deforming by application of pressure on an optical information recording substrate having the uneven surface of recorded pits and/or grooves such that one side of the photo-curable transfer sheet is in contact with the uneven surface of the optical information recording substrate,
depressing the sheet and substrate to form a laminate in which the one side of the photo-curable transfer sheet closely adheres to the uneven surface, and
exposing the photo-curable transfer sheet of the laminate to ultraviolet rays to cure the transfer sheet.

In the process, the depressing step is generally carried out under reduced pressure, whereby generation of bubbles can be suppressed. Further a reflective layer is preferably provided on the uneven surface of the optical information recording substrate. A recording layer can be provided instead of the reflective layer. In this case, a groove is generally formed instead of pits.

The second aspect of the invention is also provided by process for the preparation of an optical information recording medium comprising:
placing a photo-curable transfer sheet comprising a photo-curable composition which comprises a reactive polymer having a photopolymerizable functional group and weight-average molecular weight of not less than 5,000 and which is capable of deforming by application of pressure on an optical information recording substrate having an uneven surface of recorded pits and/or grooves such that one side of the photo-curable transfer sheet is in contact with the uneven surface of the optical information recording substrate,
depressing the sheet and substrate to allow the one side of the photo-curable transfer sheet to adhere closely to the uneven surface,
placing a stamper having an uneven surface of recorded pits and/or grooves on the photo-curable transfer sheet such that the uneven surface of the stamper is in contact with a side having no contact with the substrate of the photo-curable transfer sheet,
depressing the substrate, transfer sheet and stamper to form a laminate in which the side of the photo-curable transfer sheet adheres closely to the uneven surface of the stamper,
exposing the photo-curable transfer sheet of the laminate to ultraviolet rays to cure the transfer sheet, and
removing the stamper out of the laminate to form unevenness (e.g., recording pits) on a surface of the cured photo-curable transfer sheet.

In the process, it is preferred that an organic polymer film is further provided on the (cured) surface having an unevenness of the cured photo-curable transfer sheet through an adhesive layer. Moreover, another photo-curable transfer sheet can be further depressed on the cured surface having an unevenness of the cured photo-curable transfer sheet and cured by exposing another transfer sheet to ultraviolet rays. It is preferred that a reflective layer has been provided on the unevenness surface of the substrate, and a semitransparent reflective layer is further provided on the surface having an unevenness of the cured photo-curable transfer sheet. The depressing step is preferably carried out under reduced pressure.

In the process, the photo-curable composition of the photo-curable transfer sheet preferably has a glass transition temperature of not more than 20° C., which renders the formation of unevenness by depression at room temperature easy. The photo-curable transfer sheet generally has a light transmittance of not less than 70% in a wavelength rang of 380 to 420 nm, preferably in a wavelength rang of 380 to 600 nm, especially in a wavelength rang of 380 to 800 nm. It is ensured that an optical disc obtained by using the transfer sheet having the light transmittance is read out without error if the disc is done by irradiation of laser. Moreover, the photo-curable transfer sheet generally has cure shrinkage of not more than 8%.

Further, the reactive polymer preferably has a glass transition temperature of not more than 20° C. Further the reactive polymer preferably has 1 to 50% by mole of the photopolymerizable functional group whereby appropriate curing property of the polymer or appropriate strength of the cured polymer is ensured. The photopolymerizable functional group generally is a (meth)acryloyl group in terms of curability. The preferred reactive polymer is an acrylic resin having the photopolymerizable functional group through a urethane bond. The photo-curable composition generally contains 0.1 to 10% by weight of a photopolymerization initiator. The photo-curable transfer sheet preferably has a thickness of 1 to 1,200 μm, especially 5 to 300 μm in terms of transferring properties and workability. It is preferred that at least one side of the photo-curable transfer sheet preferably has a surface roughness (Ra) of not more than 30 nm, especially not more than 10 nm.

The third aspect of the invention is provided by a photo-curable transfer sheet comprising a photo-curable composition which comprises a reactive polymer having a photopolymerizable functional group and weight-average molecular weight of not less than 5,000 and which is capable of deforming by application of pressure, at least one side of the photo-curable transfer sheet having a surface roughness (Ra) of not more than 30 nm (especially not more than 10 nm).

In the photo-curable transfer sheet, the photo-curable composition preferably has a glass transition temperature of not more than 20° C., which makes the formation of unevenness by depression at room temperature easy. The photo-curable transfer sheet generally has a light transmittance of not less than 70% in a wavelength rang of 380 to 420 nm, preferably in a wavelength rang of 380 to 600 nm, especially in a wavelength rang of 380 to 800 nm. It is ensured that an optical disc obtained by using the transfer sheet having the light transmittance is operated without error if the disc is read out by irradiation of laser. Moreover, the photo-curable transfer sheet generally has cure shrinkage of not more than 8%.

Further, the reactive polymer preferably has 1 to 50% by mole of the photopolymerizable functional group whereby appropriate curing property of the polymer or appropriate strength of the cured polymer is ensured. The preferred reactive polymer is an acrylic resin having the photopolymerizable functional group through a urethane bond. The photopolymerizable functional group generally is a (meth)acryloyl group in terms of curing property. The photo-curable composition generally contains 0.1 to 10% by weight of a photopolymerization initiator. The photo-curable transfer sheet preferably has a thickness of 5 to 300 μm in terms of transferring properties and workability.

The photo-curable transfer sheet can be advantageously obtained by a process comprising:
melting a photo-curable composition which comprises a reactive polymer having a photopolymerizable functional group and weight-average molecular weight of not less than 5,000 and which is capable of deforming by application of pressure, and casting the melted composition onto an surface of a support, the surface having a surface roughness (Ra) of not more than 30 nm; or
a process comprising:
applying a coating liquid containing a photo-curable composition which comprises a reactive polymer having a photopolymerizable functional group and weight-average molecular weight of not less than 5,000 and which is capable of deforming by application of pressure onto a surface of a support, the surface having a surface roughness (Ra) of not more than 30 nm, and
drying a layer of the coating liquid.

In the third aspect of the present invention, a laminate in which a stamper having an uneven surface of recorded pits and/or grooves is superposed on the photo-curable transfer sheet such that the one side of the photo-curable transfer sheet adheres closely to the uneven surface can be advantageously obtained.

Further, the following articles can be advantageously obtained:
an optical information recording substrate comprising a cured film of the photo-curable transfer sheet and having an uneven surface of recorded pits and/or grooves on one side of the cured layer, the uneven surface and a reverse surface (side) of the cured layer having a surface roughness (Ra) of not more than 30 nm;
an optical information recording medium comprising an optical information recording substrate having an uneven surface of recorded pits and/or grooves and a reflective layer formed on the uneven surface, and another optical information recording substrate having an uneven surface of recorded pits and/or grooves and a semitransparent reflective layer formed on the uneven surface, both the substrates being bonded to each other through an adhesive layer such that both the reflective layers face each other,
wherein at least one of the optical information recording substrates comprises a cured film of the photo-curable transfer sheet, the uneven surface and a reversed surface (side) of the cured layer having a surface roughness (Ra) of not more than 30 nm; and
an optical information recording medium comprising an optical information recording substrate having an uneven surface of recorded pits and/or grooves and a reflective layer formed on the uneven surface, and another optical information recording substrate having an uneven surface of recorded pits and/or grooves and a semitransparent reflective layer formed on the uneven surface, both the substrates being bonded to each other through an adhesive layer such that a side having no reflective layer of the former substrate faces the semitransparent reflective layer of the latter substrate,
wherein at least one of the optical information recording substrates comprises a cured film of the photo-curable transfer sheet, the uneven surface and a reversed surface (side) of the cured layer having a surface roughness (Ra) of not more than 30 nm.

Moreover, in the third aspect, the following articles can be advantageously obtained:
an optical information recording substrate comprising a cured layer of a photo-curable transfer sheet which comprises a reactive polymer having a photopolymerizable functional group and which is capable of deforming by application of pressure, one side of the cured layer having an uneven surface of recorded pits and/or grooves, wherein a coating layer of ultraviolet curable resin is provided on the other side having no unevenness of the cured layer and cured to form cured layer as a surface smoothed layer which has a surface roughness (Ra) of not more than 30 nm;
an optical information recording medium comprising an optical information recording substrate having an uneven surface of recorded pits and/or grooves and a reflective layer formed on the uneven surface, and another optical information recording substrate having an uneven surface of recorded pits and/or grooves and a semitransparent reflective layer formed on the uneven surface, both the substrates being bonded to each other through an adhesive layer such that both the reflective layers face each other,
wherein at least one of the optical information recording substrates comprises a cured layer of the photo-curable transfer sheet which comprises a reactive polymer having a photopolymerizable functional group and weight-average molecular weight of not less than 5,000 and is capable of deforming by application of pressure, and
wherein a coating layer of ultraviolet curable resin is provided on the other side having no unevenness of the cured layer by application and cured to form a cured layer as a surface smoothed layer which has a surface roughness (Ra) of not more than 30 nm; and
an optical information recording medium comprising an optical information recording substrate having an uneven surface of recorded pits and/or grooves and a reflective layer formed on the uneven surface, and another optical information recording substrate having an uneven surface of recorded pits and/or grooves and a semitransparent reflective layer formed on the uneven surface, both the substrates being bonded to each other through an adhesive layer such that a side having no reflective layer of the former substrate faces the semitransparent reflective layer of the latter substrate,
wherein a layer comprising at least uneven surface of at least one of the optical information recording substrates comprises a cured layer of the photo-curable transfer sheet which comprises a reactive polymer having a photopolymerizable functional group and weight-average molecular weight of not less than 5,000 and is capable of deforming by application of pressure,
wherein a coating layer of ultraviolet curable resin is provided on the other side having no unevenness of the cured layer by application and cured to form a cured layer as a surface smoothed layer which has a surface roughness (Ra) of not more than 30 nm.

In the optical information recording medium, the surface roughness (Ra) preferably is not more than 10 nm. The photo-curable composition preferably has a glass transition temperature of not more than 20° C. The photo-curable transfer sheet generally has a light transmittance of not less than 70% in a wavelength rang of 380 to 420 nm, preferably in a wavelength rang of 380 to 800 nm. Further, the reactive polymer preferably has 1 to 50% by mole of the photopolymerizable functional group. The preferred reactive polymer is an acrylic resin having the photopolymerizable functional group through a urethane bond. The photopolymerizable functional group generally is a (meth)acryloyl group. The photo-curable composition generally contains 0.1 to 10% by weight of a photopolymerization initiator. The photo-curable transfer sheet preferably has a thickness of 5 to 3001 μm in terms of transferring properties and workability.

### BRIEF DESCRIPTION OF THE DRAWINGS

FIG. 1 is a section view showing an example of an embodiment of a photo-curable adhesive sheet according to a first aspect of the present invention.

FIG. 2 is a section view showing an example of a process for the preparation of the optical information recording medium according to the first aspect.

FIG. 3 is a section view showing another example of a process for the preparation of the optical information recording medium according to the first aspect.

FIG. 4 is a schematic view for explaining a depressing method using a device according to a double vacuum chamber system.

FIG. 5 is a section view showing an example of an embodiment of a photo-curable transfer sheet used in a second aspect of the present invention.

FIG. 6 is a section view showing an example of a process for the preparation of an optical information recording medium according to the second aspect.

FIG. 7 is a section view showing an example of an optical information recording medium according to the second aspect.

FIG. 8 is a section view showing examples of an embodiment of a photo-curable transfer sheet according to a third aspect of the present invention.

FIG. 9 is a section view showing an example of a process for the preparation of an optical information recording substrate and a laminate using the photo-curable transfer sheet of the third aspect.

FIG. 10 is a section view showing an example of a process for the preparation of an optical information recording medium using the photo-curable transfer sheet of the third aspect.

FIG. 11 is a section view showing an example of another optical information recording medium obtained by the process of the third aspect.

FIG. 11 is a section view showing an example of a conventional optical information recording medium.

FIG. 12 is a section view showing another example of a conventional optical information recording medium.

FIG. 13 is a section view showing a procedure for preparing a conventional optical information recording medium described in NIKKEI ELECTRONICS.

### DETAILED DESCRIPTION OF THE INVENTION

Embodiments of the invention are explained in detail by referring to drawings.

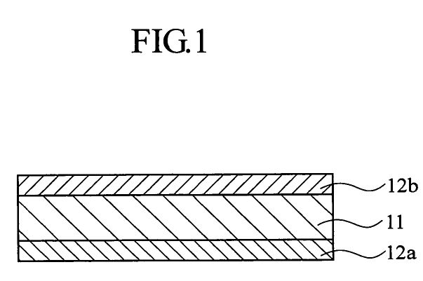

FIG. 1 is a section view showing an example of an embodiment of the photo-curable adhesive sheet 11 according to the first aspect of the present invention. In FIG. 1, the photo-curable adhesive sheet 11 has release sheets 12a, 12b on its both sides. The release sheet may be provided only on one side of the photo-curable adhesive sheet, and otherwise may not be provided, depending on uses of the resultant optical disc. The provision on the both sides is advantageous because it facilitates the handling of the adhesive sheet.

The photo-curable adhesive sheet 11 is a layer that is capable of deforming precisely along an uneven surface of, for example, an optical information substrate when the photo-curable adhesive sheet 11 is depressed on the uneven surface, and is mainly composed of a photo-curable composition which comprises a reactive polymer having a photopolymerizable functional group and weight-average molecular weight of not less than 5,000 and which has a glass transition temperature of not more than 20° C. Further, the photo-curable adhesive sheet 11 has a light transmittance of not less than 70% in a wavelength range of 380 to 420 nm such that information can be easily read out by a reading (reproduction) laser. The light transmittance is preferably not less than 80% in a wavelength range of 380 to 420 nm. Hence, an optical disc obtained by using the adhesive sheet can be advantageously used in a process for reproducing pit signals by using a reproduction laser having a laser wavelength in the range of 380 to 420 nm.

The photo-curable adhesive sheet of the invention has flexibility such that contact bonding can be carried out at room temperature as described above. Hence, the photo-curable adhesive sheet has excellent handling, and therefore can be widely used in not only information recording media such as CD, DVD, CD-R, DVD-R and DVD-RW but also the other various uses. The photo-curable adhesive sheet can be particularly advantageously used in uses requiring precise bonding, such as the preparation of an electrical appliance, a furniture, an automobile, an instrument, a sports equipment or packing materials.

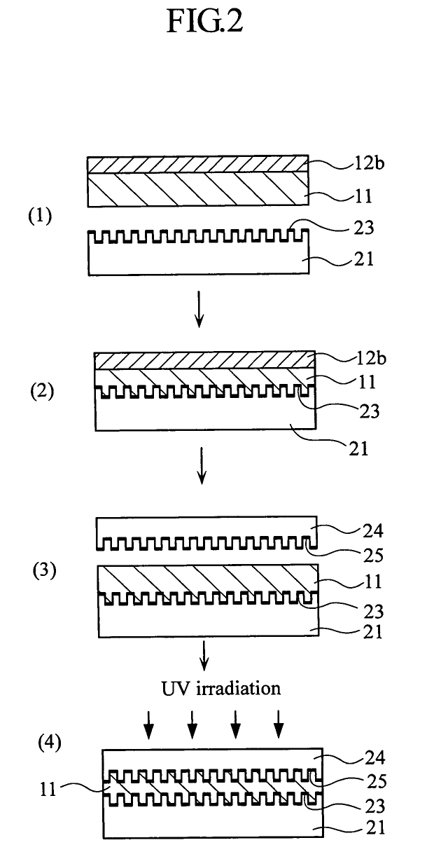

The optical information recording medium can be prepared using the above photo-curable adhesive sheet, for example, as shown in FIG. 2.

The release sheet 12a is removed from the photo-curable adhesive sheet 11 having release sheets 12a, 12b. The photo-curable adhesive sheet 11 having release sheet 12b is placed on an optical information recording substrate 21 having an uneven surface as recording pits and a reflective layer 23 (generally reflective layer of Al, Ag or the like having high reflectivity) provided on the uneven surface such that a side having no release sheet of the photo-curable adhesive sheet 11 faces the reflective layer, and they are depressed. Thus, the side of the photo-curable adhesive sheet 11 closely adheres to the uneven surface of the reflective layer to form a laminate (consisting of 12b, 11, 23 and 21). The release sheet 12b is removed from the laminate.

Subsequently, another optical information recording substrate 24 having an uneven surface as recording pits and a reflective layer 25 (or semitransparent reflective layer) provided on the uneven surface is placed on an uncured surface (having no substrate), where the release sheet 12b is removed, of the photo-curable adhesive sheet 11, such that the reflective layer 25 faces the uncured surface of optical information recording substrate 24, and they are depressed. Thus, the surface of the photo-curable adhesive sheet 11 closely adheres to the uneven surface of the reflective layer of the substrate to form a laminate (consisting of 21, 23, 11, 24 and 25). The photo-curable adhesive sheet 11 of the laminate is cured by irradiation of ultraviolet rays. Thus the optical information recording medium is obtained.

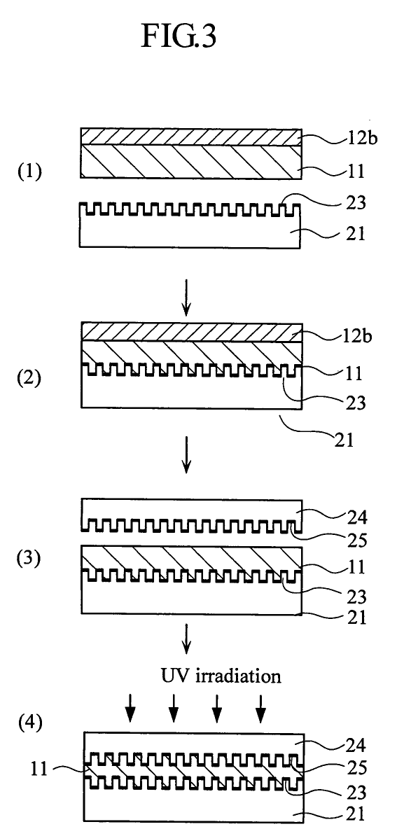

Otherwise, as shown in FIG. 3, a photo-curable adhesive sheet 11 having only a release sheet 12b is placed on an optical information recording substrate 24 having an uneven surface as recording pits and a reflective layer 23 provided on the uneven surface such that a side having no release sheet of the photo-curable adhesive sheet 11 faces the reflective layer. They are not depressed, and the release sheet 12b is removed from the adhesive sheet. Subsequently, another optical information recording substrate 24 is placed on a surface having no substrate of the photo-curable adhesive sheet 11, such that the reflective layer 25 faces the surface of the substrate 24, and then they are depressed at a time. Thus, the surface of the photo-curable adhesive sheet 11 closely adheres to the two uneven surfaces of the reflective layers of the substrates to form a laminate. The photo-curable adhesive sheet 11 of the laminate may be cured by irradiation of ultraviolet rays.

In the above procedure, a polymer sheet for protection may be bonded onto the adhesive sheet instead of another optical information recording substrate 24. In this case, there is only one uneven surface in the laminate. Otherwise, a (photo-curable or adhesive) transfer sheet is placed on an optical information recording substrate having an uneven surface as recording pits and a reflective layer provided on the uneven surface such that the transfer sheet faces the reflective layer. Subsequently, a stamper is depressed on the transfer sheet to form an uneven surface on the transfer sheet (if necessary cured), whereby a substrate having two uneven surfaces is prepared, and then a polymer sheet for protection may be bonded onto the exposed uneven surface through a photo-curable adhesive sheet of the invention.

In the above process, the optical information recording medium exclusively used for reproduction is explained. However, an optical information recording medium used for recording (writing) is also prepared in the same manner as the above process. In the recordable medium, for example, grooves or grooves and pits is provided instead of the pits, and a metal recording layer is provided instead of the reflective or semitransparent reflective layer. When the recording layer is a dye-recording layer, a recording layer and reflective layer are generally provided. Besides these points, the recordable medium can be also prepared in the same manner as above.

The optical information recording substrate may be prepared by a conventional injection molding or by the process comprising depressing a stamper on the photo-curable adhesive sheet of the invention, the adhesive sheet or the like. Thus, the optical information recording substrate of the invention can be prepared so as to have a thickness of 300 μm or less.

In the process, when the photo-curable adhesive sheet is depressed on the optical information recording substrate, or when the two optical information recording substrate are superposed on each other through the photo-curable adhesive sheet such that the reflective layers face each other, it is preferred to carry out the depressing or superposing operation under reduced pressure.

The depressing operation under the reduced pressure can be performed by a method comprising passing a substrate and photo-curable adhesive sheet or a substrate, photo-curable adhesive sheet and substrate, between two rolls under reduced pressure; or by a method comprising placing a substrate in a mold of a vacuum molding device and bring a photo-curable adhesive sheet into contact with the substrate under reduced pressure; or by a method comprising placing a substrate in a mold of a vacuum molding device and bring a photo-curable adhesive sheet and substrate into contact with the substrate under reduced pressure.

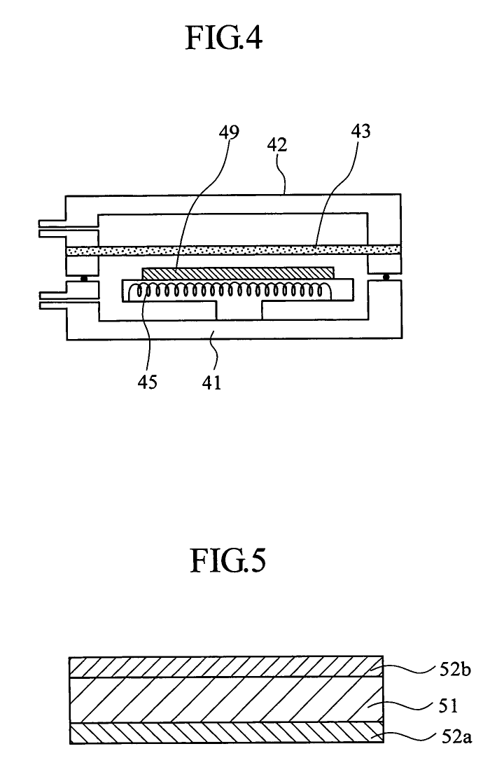

Further, the depressing operation under the reduced pressure can be performed using a device according to a double vacuum chamber system. The operation is explained by referring to FIG. 4. FIG. 4 shows a laminator according to a double vacuum chamber system. The laminator is provided with a lower chamber 41, an upper chamber 42, a sheet of silicone rubber 43 and a heater 45. A laminate 49 consisting of a substrate having unevenness and a photo-curable adhesive sheet provided thereon (or laminate of substrate/adhesive sheet/substrate) is placed in the lower chamber 41 of the laminator. Both the upper chamber 42 and lower chamber 41 are degassed or decompressed. The laminate 49 is heated with a heater 45, and air is introduced into the upper chamber 42 to allow the chamber to be at atmospheric pressure while the lower chamber 41 is kept under reduced pressure, whereby the laminate is depressed to be contact bonded. After cooling, the laminate is taken out and transformed to the next step. This operation permits sufficient deaeration under reduced pressure, and therefore, the substrate and the photo-curable adhesive sheet can be contact bonded without bubbles.

The photo-curable adhesive sheet according to the first aspect of the invention comprises a photo-curable composition which comprises a reactive polymer having a photopolymerizable functional group and weight-average molecular weight of not less than 5,000 and which has a glass transition temperature of not more than 20° C.

The photo-curable composition is generally composed mainly of the reactive polymer having a photopolymerizable functional group, a compound (e.g., monomer or oligomer) having a photopolymerizable functional group (preferably (meth)acryloyl group), a photopolymerization initiator and if necessary other additives. These are described later.

Subsequently, embodiments according to the second aspect of the invention are explained in detail by referring to the drawings.

FIG. 5 is a section view showing an example of an embodiment of the photo-curable transfer sheet 51 used in the present invention. In FIG. 5, the photo-curable transfer sheet 51 has release sheets 52a, 52b on its both sides. The release sheet may be provided on one side of the photo-curable transfer sheet, and otherwise may not be provided, depending on uses. Particularly, in a continuous preparation, the photo-curable transfer sheet 51 having no release sheets is preferred. The photo-curable transfer sheet has the same basic composition as the photo-curable adhesive sheet of the first aspect.

The photo-curable transfer sheet 51 is a layer that is easily deformed by application of pressure such that it is capable of following precisely along an uneven surface of a stamper whereby precise transferring is brought about when the photo-curable transfer sheet 51 is depressed on the uneven surface. The photo-curable transfer sheet 51 is mainly composed of a photo-curable composition which comprises a reactive polymer having a photopolymerizable functional group and weight-average molecular weight of not less than 5,000, especially the reactive polymer having a glass transition temperature of not more than 20° C. Further, the photo-curable transfer sheet 51 has a light transmittance of not less than 70% in a wavelength range of 380 to 420 nm such that information can be easily read out by a reproduction laser and can recorded in high density. The light transmittance is preferably not less than 80% in a wavelength range of 380 to 420 nm. Hence, an optical information recording medium obtained by using the transfer sheet can be advantageously used in a process for reproducing pit signals by using a reproduction laser having a laser wavelength in the range of 380 to 420 nm.

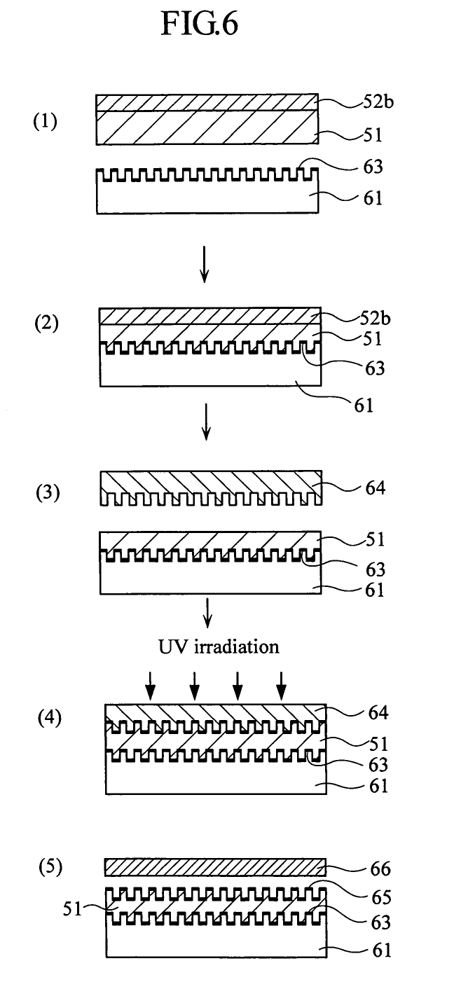

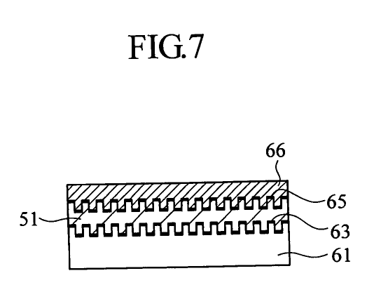

The optical information recording medium can be prepared using the above photo-curable transfer sheet, for example, as shown in FIG. 6.

The release sheet 52a is removed from the photo-curable transfer sheet 51 having release sheets 52a, 52b (step (1)). The photo-curable transfer sheet 51 having release sheet 52b is placed on an optical information recording substrate 61 having an uneven surface as recording pits and a reflective layer 63 (generally reflective layer of Al, Ag or the like having high reflectivity) provided on the uneven surface such that a side having no release sheet of the photo-curable transfer sheet 51 faces the reflective layer, and they are depressed (step (2)). Thus, the side of the photo-curable transfer sheet 51 closely adheres to the uneven surface of the reflective layer to form a laminate (consisting of 51, 63 and 61). The release sheet 52b is removed from the laminate. If this laminate is used in an optical information recording medium, the photo-curable transfer sheet 51 is cured by ultraviolet rays and then the release sheet is removed.

Subsequently, a stamper 64 having an uneven surface as recording pits is placed on an uncured surface (having no substrate), where the release sheet 52b is removed, of the photo-curable transfer sheet 51, such that the uneven surface faces the uncured surface of optical information recording substrate, and they are depressed (step (3)). Thus, the surface of the photo-curable transfer sheet 51 closely adheres to the uneven surface of the stamper 64 to form a laminate (consisting of 61, 63, 51 and 64). The photo-curable transfer sheet 51 of the laminate is then cured by irradiation of ultraviolet rays (step (4)), and the stamper is removed from the laminate to form unevenness such as recording pits on a surface of the cured sheet. Thus the optical information recording medium consisting of the substrate 61, the reflective layer 63 and the cured transfer sheet 51 is obtained. In general, a silver-alloy reflective layer (semitransparent reflective layer) 65 is formed on the unevenness (surface of the cured sheet), and further an organic polymer film (cover layer) 66 is bonded onto the silver-alloy reflective layer 65 through an adhesive layer (step (5)). On the surface of the cured sheet, a photo-curable transfer sheet may be further depressed, and cured by irradiation of ultraviolet rays. Otherwise, on the surface of the cured sheet, a UV curable resin may be further coated, and cured.

In the above process, the optical information recording medium exclusively used for reproduction is explained. However, an optical information recording medium used for recording (writing) is also prepared in the same manner as the above process. In the recordable medium, for example, grooves or grooves and pits is provided instead of the pits, and a metal recording layer is provided instead of the reflective or semitransparent reflective layer. When the recording layer is a dye-recording layer, a recording layer and reflective layer are generally provided. Besides these points, the recordable medium can be also prepared in the same manner as above.

In the second aspect according to the invention, the photo-curable transfer sheet 51 is configured such that the uneven shape of recorded pits of a substrate 61 can be precisely transferred to the photo-curable transfer sheet 51 by depressing (preferably under reduced pressure) the sheet onto the stamper at low temperature of 100° C. or less (preferably room temperature). Superposition of the stamper 61 and the photo-curable transfer sheet 51 is generally carried out using a pressure rollers or easy press (preferably under reduced pressure). The photo-curable transfer sheet 51 after curing is fairly stuck to metal used in the reflective layer, and is not easily peeled from the reflective layer. If necessary, an adhesion-promoting layer may be provided on the reflective layer.

In the invention, the photo-curable transfer sheet 51 is configured such that the uneven shape of recorded pits of the stamper 64 can be precisely transferred to photo-curable transfer sheet 51 by depressing (preferably under reduced pressure) the sheet onto the stamper at low temperature of 100° C. or less (preferably room temperature). Superposition of the stamper 64 and the photo-curable transfer sheet 51 is generally carried out using a pressure rollers or easy press (preferably under reduced pressure). The photo-curable transfer sheet 51 after curing is weakly stuck to metal such as nickel used in the stamper, and therefore the photo-curable transfer sheet 51 can be easily peeled from the stamper 21.

The substrate 61 generally is a thick plate (generally thickness of 0.3 to 1.5 mm, especially approx. 1.1 mm), and therefore it can be prepared by conventional injection molding. However, it may be prepared by using the photo-curable transfer sheet and a stumper. Since the thickness of the optical information recording substrate can be rendered small (300 μm or less) by using the photo-curable transfer sheet, another substrate is prepared by conventional injection molding and therefore its thickness is increased whereby precision of transferred pit shape can be enhanced.

In the process, when the photo-curable transfer sheet is depressed on the substrate, or when the stamper is depressed on the photo-curable adhesive sheet, it is preferred to carry out the depressing or superposing operation under reduced pressure whereby bubbles generated in the operation can be easily removed.

The depressing operation under the reduced pressure can be performed by a method comprising passing the photo-curable transfer sheet and stamper between two rolls under reduced pressure; or by a method comprising placing a stamper in a mold of a vacuum molding device and contact bonding a photo-curable transfer sheet to the stamper under reduced pressure.

Further, the depressing operation can be also performed by using the double vacuum chamber system shown in FIG. 4, which is used in the first aspect of the invention. In this case, the depressing operation is carried out under the condition that a laminate of the substrate having unevenness and photo-curable transfer sheet or a laminate of the substrate, photo-curable transfer sheet and stamper is placed in the lower chamber 41 of the laminator.

The photo-curable transfer sheet used in the second aspect of the invention preferably comprises a photo-curable composition which comprises a reactive polymer having a photopolymerizable functional group and a glass transition temperature of not more than 20° C.

The photo-curable composition is generally composed mainly of the reactive polymer having a photopolymerizable functional group, a compound (e.g., monomer or oligomer) having a photopolymerizable functional group (preferably (meth)acryloyl group), a photopolymerization initiator and if necessary other additives. The photo-curable composition used in the second aspect is basically the same as that of the photo-curable adhesive sheet of the first aspect.

Subsequently, embodiments according to the third aspect of the invention are explained in detail by referring to the drawings.

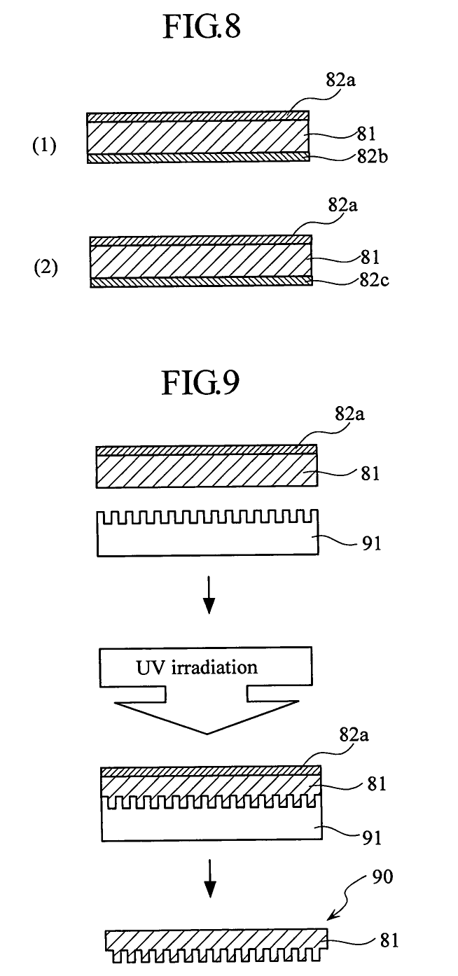

FIGS. 8(a) and (b) is a section view showing examples of embodiments of the photo-curable transfer sheet 81 used in the present invention. In FIG. 8(a), the photo-curable transfer sheet 81 has a release sheet 82a on its one side and a release sheet 82a on the other side. The release sheet may be provided on one side, and otherwise may not be provided, depending on uses. In FIG. 8(b), the photo-curable transfer sheet 81 has a release sheet 82a on its one side and a support 82c on the other side.

The photo-curable transfer sheet 81 according to the third aspect has an excellent smooth surface, and its surface roughness (Ra) is not more than 30 m, preferably not more than 10 nm. The photo-curable transfer sheet 81 having an excellent smooth surface can be obtained, for example, by casting a melt of a photo-curable composition which comprises a reactive polymer having a photopolymerizable functional group and weight-average molecular weight of not less than 5,000 and which is capable of deforming by application of pressure on a surface of a support, the surface having a surface roughness (Ra) of not more than 30 nm. Example of the support includes a film made of polycarbonate, which is commercially available. Otherwise, the photo-curable transfer sheet 81 can be obtained, for example, by applying a coating liquid of the above photo-curable composition onto a surface of the support having a surface roughness (Ra) of not more than 30 m (especially not more than 10 nm), and drying a layer of the coating liquid. However, the former method is preferred since it brings about a lower surface roughness.

It is preferred that the photo-curable transfer sheet 81 is mainly composed of a photo-curable composition which comprises a reactive polymer having a photopolymerizable functional group and a glass transition temperature of not more than 20° C. Further, the photo-curable transfer sheet has a light transmittance of not less than 70% in a wavelength range of 380 to 420 nm such that information can be easily read out by a reproduction laser. The light transmittance is preferably not less than 80% in a wavelength range of 380 to 420 nm. Hence, an optical information recording medium obtained by using the transfer sheet can be advantageously used in a process for reproducing pit signals by using a reproduction laser having a laser wavelength in the range of 380 to 420 nm.

The optical information recording substrate and laminate can be prepared using the above photo-curable transfer sheet 81, for example, as shown in FIG. 9.

When the photo-curable transfer sheet 81 having release sheets 82a, 82a on both sides is used, the preparation is carried out below. The release sheet 82b is removed from the photo-curable transfer sheet 81, and the transfer sheet is disposed on an uneven surface of a stamper 91 having the uneven surface of recorded pits such that a surface having no release sheet of the photo-curable transfer sheet 81 faces the uneven surface, and they are superposed and depressed such that the photo-curable transfer sheet 81 is brought into close contact with the uneven surface, whereby a laminate having the stamper 91 and the photo-curable transfer sheet 81 is obtained. Then, the release sheet 82a of the photo-curable transfer sheet 81 is exposed to UV (ultraviolet rays), whereby the photo-curable transfer sheet 81 is cured and then the stamper 91 and the release sheet 82a are removed from the laminate to obtain the cured photo-curable transfer sheet 81 having unevenness (i.e., optical information recording substrate) 90. The surface having no unevenness of this substrate has a surface roughness (Ra) is not more than 30 nm, preferably not more than 10 nm.

In case the photo-curable transfer sheet 81 having a release sheet 82a on its one side and a support 82c on the other side is used, the resultant substrate has a smooth surface of the support and both smooth surfaces in the interface between the support and transfer sheet, these surfaces having a surface roughness (Ra) is not more than 30 nm, preferably not more than 10 nm.

In the invention, the photo-curable transfer sheet is configured such that the uneven shape of recorded pits of the stamper 91 can be precisely transferred to the photo-curable transfer sheet by depressing the sheet onto the stamper at low temperature of 100° C. or less. Superposition of the stamper 91 and the photo-curable transfer sheet 81 is generally carried out using a pressure rollers or easy press, preferably under reduced pressure. The photo-curable transfer sheet 81 after curing is weakly stuck to metal such as nickel used in the stamper, and therefore the photo-curable transfer sheet 81 can be easily peeled from the stamper 91.

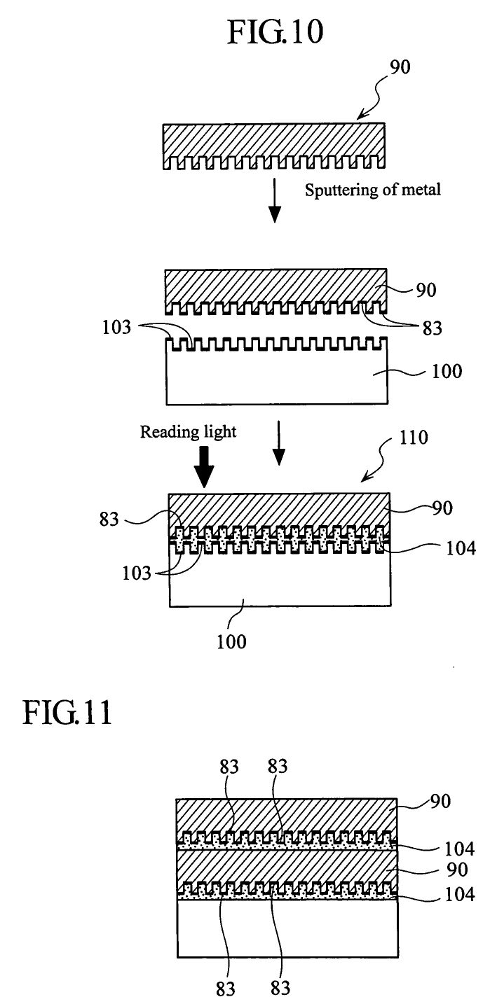

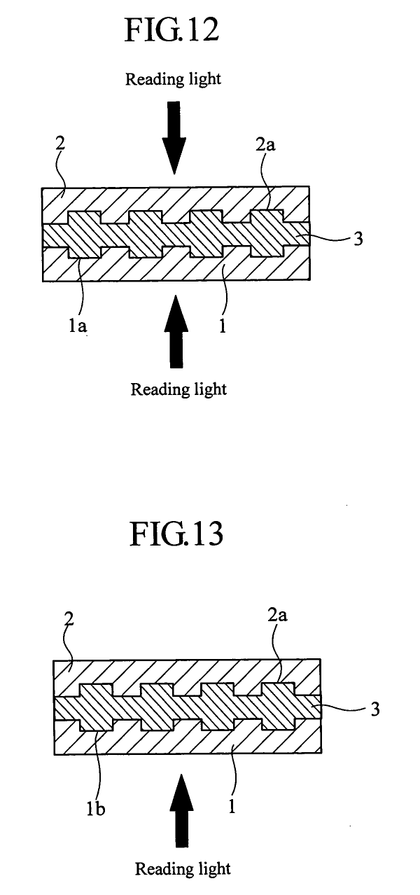

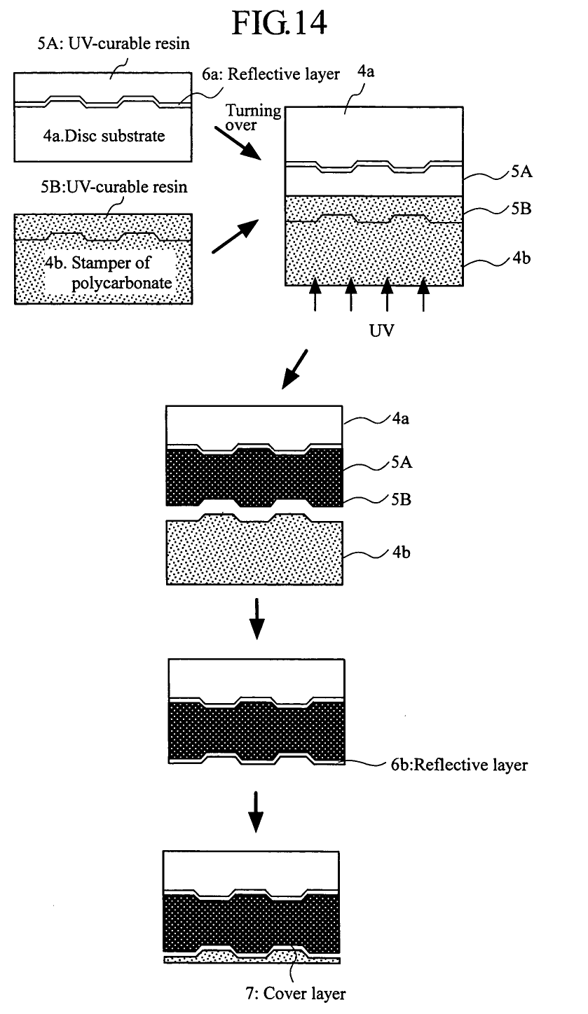

The optical information recording medium can be prepared using the above-mentioned optical information recording substrate 90, for example, as shown in FIG. 10.

The uneven surface of the optical information recording substrate 90 obtained above is metallized (deposited) by sputtering process using silver alloy, whereby a silver-alloy reflective layer (semitransparent reflective layer) 83 is formed on the substrate. Separately, the uneven surface of an optical information recording substrate 100 is metallized by sputtering process using aluminum, whereby an Al reflective layer 103 (or silver-alloy reflective layer having higher reflectivity than the layer 83) is formed on the substrate. The substrate 90 having the semitransparent reflective layer 83 and the substrate 100 having the Al reflective layer 103 are disposed such that both the reflective layers face each other and superposed through an adhesive, and the adhesive is cured to form an adhesive layer 104, whereby the optical information recording medium 110 is obtained. The surface having no unevenness of the sheet 11 of this optical information recording medium 110 has a surface roughness (Ra) of not more than 30 nm (especially not more than 10 nm). Since reading of signals is carried out by exposing a reproduction light (laser) to the surface, there are little errors in reading. On this surface, further a support or a protective film may be provided.

In the above process, the optical information recording medium exclusively used for reproduction is explained. On the other hand, in the recordable medium, for example, grooves or grooves and pits is provided instead of the pits, and a metal recording layer is provided instead of the reflective layer or semitransparent reflective layer. When the recording layer is a dye-recording layer, a recording layer and reflective layer are provided. Besides the points, the recordable medium is prepared in the same manner as the above process.

The optical information recording substrate 100, which is generally a thick plate, may be prepared by a conventional injection molding or by the process for the preparation of the optical information recording substrate as mentioned previously. The optical information recording substrate can be prepared so as to have a thickness of 300 μm or less, and therefore, when another substrate is prepared by a conventional process, the thickness of the another substrate can be increased to enhance the precision of pit and/or groove shape. The adhesives used for forming the adhesive layer include a conventional hot-melt type adhesive, a UV-curable resin adhesive and a pressure-sensitive contact adhesive.

Further, the following media are preferred: Two optical information recording substrates 90 mentioned above, i.e., one substrate having a full reflective layer such as Al layer and the other substrate having a semitransparent reflective layer, are prepared, the two substrates are bonded to each other through an adhesive such that the semitransparent reflective layer faces the surface having no unevenness to form a laminate, and another laminate is prepared in the same manner as above, the resultant two laminates are bonded to each other through an adhesive such that both the reflective layers face each other, and hence an optical information recording medium having four recorded surfaces is obtained. Further, the above one laminate is bonded onto a transparent supporting substrate whereby an optical information recording medium shown in FIG. 11 can be obtained. Furthermore, the above one laminate is bonded onto a conventional transparent supporting substrate having uneven surface and a reflective layer thereon to give an optical information recording medium. In these media, the semitransparent reflective layer is provided on the incident side of the reading laser beam.

These media can be used as conventional four-layer type and three-layer type in double sides reading system and two-layer type in single side reading system, respectively.

Otherwise, unevenness is formed on a part of a substrate, a reflective layer is formed thereon, and a recording layer, on which information can be written, may be provided thereon.

Based on the process explained above by referring to FIGS. 9 and 10, another procedure to obtain the optical information recording medium having the specific surface roughness is described below. The procedure is carried out by using a photo-curable transfer sheet having no smooth surface instead of the transfer sheet having the specific surface roughness and, after preparation of a laminate, giving surface smoothness to the resultant laminate. This procedure can be also applied to the case that the transfer sheet of the medium has insufficiently smooth surface, which results from treatments during the preparation of medium even if a release sheet having excellent smooth surface is used, or from the use of a release sheet having poor smooth surface.

In FIG. 9, after the preparation of the optical information recording substrate 90 (i.e., cured photo-curable transfer sheet having unevenness 81), a coating liquid of ultraviolet curable resin is applied onto the reverse surface having no unevenness of the substrate by a spin coater or a screen printing method and the resultant coating liquid layer is exposed to ultraviolet rays for curing the layer, in order to enhance smoothness of the surface. The coating liquid of an ultraviolet curable resin mainly comprises compounds having a photopolymerizable functional group(s) and a photopolymerization initiator as described later, and further a surfactant such as a leveling agent and if desired an organic solvent. Further, in order to enhance the smoothness of the surface, in addition to the surfactant such as a leveling agent, polymers described later may be added to the coating liquid. Besides the above additives, the coating liquid may contain a UV light absorber, an aging resistant agent, a dye and/or a processing auxiliary. If necessary, the coating liquid may contain a particle of material such as silica gel, calcium carbonate or silicone copolymer in a small amount. It is generally preferred to use an ultraviolet curable resin for forming hard coat layer, which has excellent leveling prosperity and also can give high hardness.

The conditions for application of the coating liquid generally include viscosity of the coating liquid in the range of 10 to 1,000 [mPas/25° C.], the setting time in the range of 1 to 100 sec., the exposing time in the range of 1 to 20 sec., and the thickness in the range of 1 to 10 μm.

The application of the coating liquid can be carried out in an appropriate step in the process shown in FIG. 10. For example, the application can be carried out after metal is sputtered, or after the medium is finished.

In the process, when the photo-curable transfer sheet is depressed on the stamper, or when the two optical information recording substrates are superposed on each other through adhesive such that the reflective layers face each other, it is preferred to carry out the depressing or superposing operation under reduced pressure whereby bubbles generated in the operation can be smoothly moved.

The depressing operation under the reduced pressure can be performed by a method comprising passing the photo-curable transfer sheet and stamper between two rolls under reduced pressure; or by a method comprising placing a stamper in a mold of a vacuum molding device and contact bonding a photo-curable transfer sheet to the stamper under reduced pressure.

Further, the depressing operation can be also performed by using the double vacuum chamber system shown in FIG. 4, which is used in the first aspect of the invention. In this case, the depressing operation is carried out under the condition that a laminate the substrate, photo-curable transfer sheet and stamper, or a laminate of the substrate, adhesive and substrate (the substrates having unevenness) is placed in the lower chamber 41 of the laminator.

The photo-curable transfer sheet according to the third aspect of the invention preferably consists mainly of a photo-curable composition which comprises a reactive polymer having a photopolymerizable functional group and weight-average molecular weight of not less than 5,000 and especially which has a glass transition temperature of not more than 20° C. The transfer sheet has the same construction as that of the second aspect expect that it has a smooth surface.

The photo-curable composition of the invention is generally composed mainly of the reactive polymer having a photopolymerizable functional group, a compound (e.g., monomer or oligomer) having a photopolymerizable functional group (preferably (meth)acryloyl group), a photopolymerization initiator, and if necessary other additives.

Examples of the reactive polymer having a photopolymerizable functional group include homopolymers or copolymers (i.e., acrylic resins having a photopolymerizable functional group) derived from alkyl acrylate (e.g., methyl acrylate, ethyl acrylate, butyl acrylate, 2-ethylhexyl acrylate) and/or alkyl methacrylate (e.g., methyl methacrylate, ethyl methacrylate, butyl methacrylate, 2-ethylhexyl methacrylate) and having a photopolymerizable functional group on its main chain or side chain. These (co)polymers can be obtained, for example, by copolymerizing one or more (meth)acrylate mentioned above with (meth)acrylate (e.g., 2-hydroxyethyl (meth)acrylate) having a functional group such as —OH and reacting the resultant polymer with a compound (e.g., isocyanatoalkyl (meth)acrylate) having a functional group capable of reacting with the functional group of the polymer and having a photopolymerizable functional group. Thus an acrylic resin having a photopolymerizable functional group through a urethane bond is preferred.

The reactive polymer of the invention has generally 1 to 50% by mole, preferably 5 to 30% by mole of the photopolymerizable functional group. Examples of the photopolymerizable functional group preferably include acryloyl, methacryloyl and vinyl groups, especially acryloyl and methacryloyl groups.

In case the reactive polymer having glass transition temperature of not more than 20° C. is used as above, the resultant photo-curable sheet having flexibility can follow exactly the uneven surface of the stamper even at room temperature when the sheet is depressed on the stamper. The reactive polymer especially has glass transition temperature of 15 to −50° C. because the resultant photo-curable layer can follow more exactly the uneven surface. When the glass transition temperature exceeds the upper limit, high pressure and temperature is needed in the depressing and bonding steps of the sheet, which brings about lowering of workability. When the glass transition temperature falls to below the lower limit, the resultant cured sheet does not have sufficient hardness.

The reactive polymer of the invention generally has number-average molecular weight of 5,000 to 1,000,000, preferably 10,000 to 300,000, and/or generally has weight-average molecular weight of 5,000 to 1,000,000, preferably 10,000 to 300,000.

Examples of the compounds having a photopolymerizable group include (meth)acrylate monomers such as 2-hydroxyethyl(meth)acrylate, 2-hydroxyropyl(meth)acrylate, 4-hydroxybutyl(meth)acrylate, 2-ethylhexylpolyethoxy(meth)acrylate, benzyl(meth)acrylate, isobornyl(meth)acrylate, phenyloxyethyl(meth)acrylate, tricyclodecane mono(meth)acrylate, dicyclopentenyloxyethyl(meth)acrylate, tetrahydrofurfuryl(meth)acrylate, acryloylmorpholine, N-vinylcaprolactam, 2-hydroxy-3-phenyloxypropyl(meth)acrylate, o-phenylphenyloxyethyl(meth)acrylate, neopentylglycol di(meth)acrylate, neopentyl glycol dipropoxydi(meth)acrylate, neopentyl glycol hydroxypivalate di(meth)acrylate, tricyclodecanedimethylol di(meth)acrylate, 1,6-hexanediol di(meth)acrylate, nonanediol di(meth)acrylate, trimethylolpropane tri(meth)acrylate, pentaerythritol tri(meth)acrylate, pentaerythritol tetra(meth)acrylate, tris[(meth)acryloxyethyl]isocyanurate and ditrimethylolpropane tetra(meth)acrylate; and
the following (meth)acrylate oligomer such as:
polyurethane (meth)acrylate such as compounds obtained by reaction of:
a polyol compound (e.g., polyol such as ethylene glycol, propylene glycol, neopentyl glycol, 1,6-hexanediol, 3-methyl-1,5-pentanediol, 1,9-nonanediol, 2-ethyl-2-butyl-1,3-propanediol, trimethylolpropane, diethylene glycol, dipropylene glycol, polypropylene glycol, 1,4-dimethylolcyclohexane, bisphenol-A polyethoxydiol and polytetramethylene glycol; polyesterpolyol obtained by reaction of the above-mentioned polyol and polybasic acid or anhydride thereof such as succinic acid, maleic acid, itaconic acid, adipic acid, hydrogenated dimer acid, phthalic acid, isophthalic acid and terephthalic acid; polycaprolactone polyol obtained by reaction of the above-mentioned polyol and ε-caprolactone; a compound obtained by reaction of the above-mentioned polyol and a reaction product of the above-mentioned polybasic acid or anhydride thereof and ε-caprolactone; polycarbonate polyol; or polymer polyol), and
an organic polyisocyanate compound (e.g., tolylene diisocyanate, isophorone diisocyanate, xylylene diisocyanate, diphenylmethane-4,4′-diisocyanate, dicyclopentanyl diisocyanate, hexamethylene diisocyanate, 2,4,4′-trimethylhexamethylene diisocyanate, 2,2′,4′-trimethylhexamethylene diisocyanate), and
hydroxyl-containing (meth)acrylate (e.g., 2-hydroxyethyl (meth)acrylate, 2-hydroxyropyl (meth)acrylate, 4-hydroxybutyl (meth)acrylate, 2-hydroxy-3-phenyloxypropyl (meth)acrylate, cyclohexane-1,4-dimethylolmono(meth)acrylate, pentaerythritol tri(meth)acrylate or glycerol di(meth)acrylate);
bisphenol-type epoxy(meth)acrylate obtained by reaction of bisphenol-A epoxy resin or bisphenol-F epoxy resin and (meth)acrylic acid.

These compounds having photopolymerizable functional group can be employed singly or in combination of two or more kinds.

Any photopolymerization initiators known can be used in the invention. The initiators having good storage-stability after mixing with other components are preferred. Examples of the photopolymerization initiators include acetophenone type initiators such as 2-hidroxy-2-methyl-1-phenylpropane-1-on, 1-hydroxycyclohexylphenylketone and 2-methyl-1-[4-(methylthio)phenyl]-2-morphorino-propane-1-on; benzoin type initiators such as benzylmethylketal; benzophenone type initiators such as benzophenone, 4-phenylbenzophenone and hydroxybenzophenone; thioxanthone type initiators such as isopropylthioxanthone and 2,4-diethythioxanthone. Further, as special type, there can be mentioned methylphenylglyoxylate. Especially preferred are 2-hidroxy-2-methyl-1-phenylpropane-1-on, 1-hydroxycyclohexylphenylketone, 2-methyl-1-[4-(methylthio)phenyl]-2-morphorino-propane-1-on and benzophenone. These photopolymerization initiators can be employed together with one or more kinds of a photopolymerization promoter such as a benzoic acid type compound (e.g., 4-dimethylaminobezoic acid) or a tertiary amine compound by mixing the initiator with the promoter in optional ratio. Only the initiator can be employed singly or in combination of two or more kinds. The initiator is preferably contained in the photo-curable composition in the range of 0.1 to 20% by weight, particularly 1 to 10% by weight.

In addition to the above-mentioned photopolymerizable initiators, the acetophenone type initiator includes 4-phenoxydichloroacetophenone, 4-t-butyldichloroacetophenone, 4-t-butyltrichloroacetophenone, diethoxyacetophenone, 2-hidroxy-2-methyl-1-phenylpropane-1-on, 1-(4-isopropylphenyl)-2-hidroxy-2-methylpropane-1-on, 1-(4-dodecylphenyl)-2-hydroxy-2-methylpropane-1-on, 4-(2-hydroxyethoxy)-phenyl(2-hydroxy-2-propyl)ketone, 1-hydroxycyclohexylphenylketone, 2-methyl-1-[4-(methylthio)phenyl]-2-morphorino-propane-1-on; and the benzophenone type initiators include benzophenone, benzoylbenzoic acid, methyl benzoylbenzoate, 4-phenylbenzophenone, hydroxybenzophenone, 4-benzoyl-4′-methylphenylsulfide and 3,3′-dimethyl-4-methoxybenzophenone.

The acetophenone type initiators preferably are 2-hidroxy-2-methyl-1-phenylpropane-1-on, 1-hydroxycyclohexylphenylketone, 2-methyl-1-[4-(methylthio)phenyl]-2-morphorino-propane-1-on, and the benzophenone type initiators preferably are benzophenone, benzoylbenzoic acid and methyl benzoylbenzoate.

Preferred examples of the tertiary amine compounds of the photopolymerization promoter include triethanolamine, methyldiethanolamine, triisopropanolamine, 4,4′-dimethylaminobenzophenone, 4,4′-diethylaminobenzophenone, ethyl 2-dimethylaminobenzonate, ethyl 4-dimethylaminobenzonate, (n-butoxy)ethyl 4-dimethylaminobenzonate, isoamyl 4-dimethylaminobenzonate and 2-ethylhexyl 4-dimethylaminobenzonate. Especially preferred are ethyl 4-dimethylaminobenzonate, (n-butoxy)ethyl 4-dimethylaminobenzonate, isoamyl 4-dimethylaminobenzonate and 2-ethylhexyl 4-dimethylaminobenzonate.

The photo-curable composition of the invention is preferably configured such that the photo-curable (adhesive or transfer) sheet has a glass transition temperature of not more than 20° C. and the photo-curable (adhesive or transfer) sheet before and after curing has a transmittance of not less than 70%. Therefore the photo-curable composition preferably contains, in addition to the compound having a photopolymerizable functional group and the photopolymerization initiator, if desired the following thermoplastic resin and other additives.

The ratio by weight of the reactive polymer: the compound having a photopolymerizable functional group: the photopolymerization initiator generally is 40-100:0-60:0.1-10, preferably 60-100:0-40:1-10, especially 50-80:20-50:1-10.

As other additives, a silane coupling agent can be used for enhancing the adhesive strength. Examples of the silane coupling agent include vinyltriethoxysilane, vinyltris(β-methoxyethoxy)silane, γ-methacryloxypropylmethoxysilane, vinyltriacetoxysilane, γ-glycidoxypropyltrimethoxysilane, γ-glycidoxypropyltriethoxysilane, β-(3,4-epoxycyclohexyl)ethyltrimethoxysilane, γ-chloropropylmethoxysilane, vinyltrichlorosilane, γ-mercaptopropylmethoxysilane, γ-aminopropyltriethoxysilane, N-β-(aminoethyl)-γ-aminopropyltrimethoxysilane. The silane coupling agent can be used singly, or in combination of two or more kinds. The silane coupling agent is preferably used in the range of 0.01 to 5 weight by part based on 100 parts by weight of the above reactive polymer.

Similarly, an epoxy group-containing compound can be used for enhancing the adhesive strength. Examples of the epoxy group-containing compounds include triglycidyl tris(2-hydroxyethyl)isocyanurate, neopentylglycol diglycidyl ether, 1,6-hexanediol diglycidyl ether, allyl glycidyl ether, 2-ethylhexyl glycidyl ether, phenyl glycidyl ether, phenol glycidyl ether, p-tert-butylphenyl glycidyl ether, diglycidyl adipate, diglycidyl o-phthalate, glycidyl methacrylate and butyl glycidyl ether. Further, the similar effect is also obtained by using an oligomer having an epoxy group and molecular weight of hundreds to thousands, or a polymer having an epoxy group and molecular weight of thousands to hundreds of thousands. The content of the compound having an epoxy group is sufficient in the range of 0.1 to 20 parts by weight based on 100 parts by weight of the reactive polymer, particularly 1 to 10% by weight. At least one of the compounds having an epoxy group can be used singly or in combination of two or more kinds.

As other additives, further a hydrocarbon resin can be used for improving processing properties such as laminating properties. The hydrocarbon resin may be either natural resin or synthetic resin. Examples of the natural resins preferably include rosins, rosin derivatives and terpene resins. Examples of the rosins include gum resins, tall oil resins, wood resins. Examples of the rosin derivatives include hydrogenated rosins, disproportionated rosins, polymerized rosins, esterificated rosins, metal salts of rosins. Examples of the terpene resins include α-pinene resins, β-pinene resins, and terpene phenol resins. Moreover, as the natural resin, dammar, copal, shellac can be used. Examples of the synthetic resins preferably include petroleum resins, phenol resins, and xylene resins. Examples of the petroleum resins include aliphatic petroleum resins, aromatic petroleum resins, cycoaliphatic petroleum resins, copolymer type petroleum resins, hydrogenated petroleum resins, pure monomer type petroleum resins, and coumarone-indene resins. Examples of the phenol resins include alkylphenol resins and modified phenol resins. Examples of the xylene resins include xylene resins and modified xylene resins.

Furthermore, acrylic resin can be employed in the invention. For example, homopolymers and copolymers obtained from alkyl acrylate(s) such as methyl acrylate, ethyl acrylate and butyl acrylate and/or alkyl methacrylate(s) such as methyl methacrylate, ethyl methacrylate and butyl methacrylate can be used. Copolymers of these monomers and other copolymerizable monomers can be also used. In view of reactivity in the photo curing step and durability and transparency of cured product, polymethyl methacrylate (PMMA) is preferred.

The above-mentioned polymer such as hydrocarbon resin can be used in the amount of 1 to 20 parts by weight, preferably 5 to 15 parts by weight based on 100 parts by weight of the reactive polymer.

The photo-curable composition may contain, in addition to the above-mentioned additives, an ultraviolet absorber, an aging resistant agent, a dye, and a processing auxiliary agent in a small amount. If desired, particles of silica gel, calcium carbonate or silicone copolymer may be contained in a small amount.

The photo-curable adhesive or transfer sheet comprising the photo-curable composition of the invention is generally prepared by homogeneously mixing the reactive polymer, a compound having a photopolymerizable functional group (monomer and oligomer) and if desired other additives, kneading the mixture using an extruder or roll, and subjecting the kneaded mixture to a film-forming process using a calendar, roll, T-die extrusion or inflation to form a film of a predetermined dimension. When a support is used, it is needed to form a film on the support. A more preferred process for forming the photo-curable sheet comprises the steps of: dissolving homogeneously the components in a good solvent, applying the resultant solution onto a separator coated closely with silicone or fluoric resin (or the support) by means of flow-coater method, roll-coater method, gravure-roll method, mayer-bar method or lip-die coating method, and vaporizing the solvent.

The surface of the photo-curable sheet may be embossed in the film formation process to prevent blocking and facilitate deaeration in the step depressing the sheet and the substrate or stamper. As methods for the embossing processing, conventional methods such as a method using embossing roll can be adopted. In a process for applying a solution, it is possible that the solution is applied onto an embossed film or paper having release properties whose emboss shape is transferred to the sheet. Mean surface roughness (Ra) of the embossed surface is generally not more than 50 μm, preferably 0.01 to 50 μm, especially 0.1 to 20 μm, whereby air is easily escaped from an interface between the sheet and a device to permit the embossed surface of the sheet to fill up complicated unevenness of the device. The mean surface roughness of less than 0.01 μm is apt to bring about poor deaeration, whereas the mean surface roughness of more than 50 μm occasionally allows the unevenness of the sheet to remain in the depressing step.

The thickness of the photo-curable adhesive or transfer layer generally is in the range of 1 to 1,200 μm, preferably 5 to 500 μm, especially 5 to 300 μm. When the thickness is thinner than 1 μm, sealing properties are lowered and maybe the sheet does not full up the unevenness of the transparent substrate. When the thickness is thicker than 1,200 μm, the thickness of the resultant recording medium is so thick whereby trouble in housing or storing of the medium and the resultant assembly or reverse influence in light transmittance possibly occurs.

The release sheet preferably comprises transparent organic resin having a glass transition temperature of not less than 50° C. The release sheet generally is a transparent resin sheet mainly consisting of organic resin such as polyester resin (e.g., polyethylene terephthalate, polycyclohexylene terephthalate, polyethylene naphthalate), polyamide (e.g., nylon 46, modified nylon 6T, nylon MXD6, polyphthalamide), ketone resin (e.g., polyphenylene sulfide, polythioether sulfone), sulfone resin (e.g., polysulfone, polyether sulfone), polyether nitrile, polyarylate, polyether imide, polyamideimide, polycarbonate, polymethyl methacrylate, triacetylcellulose, polystyrene or polyvinyl chloride. Of these resins, polycarbonate, polymethyl methacrylate, polyvinyl chloride, polystyrene and polyethylene terephthalate can be preferably employed. The thickness is generally in the range of 10 to 200 μm, especially in the range of 30 to 100 μm.

The photo-curable transfer sheet having a smooth surface according to the third aspect can be, for example, obtained by extruding the kneaded mixture as mentioned above to cast and cool a sheet having a surface roughness (Ra) of not more than 30 nm. If necessary, the other surface may be covered by a sheet (release sheet). Otherwise, the photo-curable transfer sheet can be, for example, obtained by dissolving homogeneously the components in a good solvent, applying the resultant solution onto a separator coated closely with silicone or fluoric resin (support) by means of flow-coater method, roll-coater method, gravure-roll method, mayer-bar method or lip-die coating method, and vaporizing the solvent. Particularly, the photo-curable transfer sheet having a smooth surface can be obtained by applying the resultant solution onto a support (preferably polycarbonate sheet) having a surface roughness of not more than 30 nm, and drying the solution layer.

The thickness of the photo-curable transfer sheet of the third aspect is in the range of 1 to 1,200 μm, preferably 5 to 500 μm, especially 5 to 300 μm (particularly not more than 150 μm). When the thickness is thinner than 1 μm, sealing properties are lowered and maybe the sheet does not full up the unevenness of the transparent substrate. When the thickness is thicker than 1,200 μm, the thickness of the resultant recording medium is so thick whereby trouble in housing or storing of the medium and the resultant assembly or reverse influence in light transmittance possibly occurs.

The support of the third aspect preferably comprises transparent organic resin having a glass transition temperature of not less than 50° C. The support generally is a transparent resin sheet mainly consisting of organic resin such as polyester resin (e.g., polyethylene terephthalate, polycyclohexylene terephthalate, polyethylene naphthalate), polyamide (e.g., nylon 46, modified nylon 6T, nylon MXD6, polyphthalamide), ketone resin (e.g., polyphenylene sulfide, polythioether sulfone), sulfone resin (e.g., polysulfone, polyether sulfone), polyether nitrile, polyarylate, polyether imide, polyamideimide, polycarbonate, polymethyl methacrylate, triacetylcellulose, polystyrene or polyvinyl chloride. Of these resins, polycarbonate, polymethyl methacrylate, polyvinyl chloride, polystyrene and polyethylene terephthalate are excellent in transparency and birefringence, and therefore can be preferably employed.

The release sheet having surface roughness (Ra) of not more than 30 nm according to the third aspect preferably comprises transparent organic resin having a glass transition temperature of not less than 50° C. The release sheet generally is a transparent resin sheet mainly consisting of organic resin such as polyester resin (e.g., polyethylene terephthalate, polycyclohexylene terephthalate, polyethylene naphthalate), polyamide (e.g., nylon 46, modified nylon 6T, nylon MXD6, polyphthalamide), ketone resin (e.g., polyphenylene sulfide, polythioether sulfone), sulfone resin (e.g., polysulfone, polyether sulfone), polyether nitrile, polyarylate, polyether imide, polyamideimide, polycarbonate, polymethyl methacrylate, triacetylcellulose, polystyrene or polyvinyl chloride. Of these resins, polycarbonate, polymethyl methacrylate, polyvinyl chloride, polystyrene and polyethylene terephthalate are excellent in transparency, and therefore can be preferably employed.

The substrate having uneven surface used in the invention preferably comprises transparent organic resin having a glass transition temperature of not less than 50° C. The substrate generally is a transparent resin sheet mainly consisting of organic resin such as polyester resin (e.g., polyethylene terephthalate, polycyclohexylene terephthalate, polyethylene naphthalate), polyamide (e.g., nylon 46, modified nylon 6T, nylon MXD6, polyphthalamide), ketone resin (e.g., polyphenylene sulfide, polythioether sulfone), sulfone resin (e.g., polysulfone, polyether sulfone), polyether nitrile, polyarylate, polyether imide, polyamideimide, polycarbonate, polymethyl methacrylate, triacetylcellulose, polystyrene or polyvinyl chloride. Of these resins, polycarbonate, polymethyl methacrylate, polyvinyl chloride, polystyrene and polyethylene terephthalate are excellent in transferring properties, transparency and birefringence, and therefore can be preferably employed. The thickness is generally in the range of 200 to 2,000 μm, especially in the range of 50 to 1,500 μm.

The polymer film for protection used in the invention preferably comprises transparent organic resin having a glass transition temperature of not less than 50° C. The film generally is a transparent resin sheet mainly consisting of organic resin such as polyester resin (e.g., polyethylene terephthalate, polycyclohexylene terephthalate, polyethylene naphthalate), polyamide (e.g., nylon 46, modified nylon 6T, nylon MXD6, polyphthalamide), ketone resin (e.g., polyphenylene sulfide, polythioether sulfone), sulfone resin (e.g., polysulfone, polyether sulfone), polyether nitrile, polyarylate, polyether imide, polyamideimide, polycarbonate, polymethyl methacrylate, triacetylcellulose, polystyrene or polyvinyl chloride. Of these resins, polycarbonate, polymethyl methacrylate, polyvinyl chloride, polystyrene and polyethylene terephthalate are excellent in transparency and birefringence, and therefore can be preferably employed. The thickness is generally in the range of 10 to 200 μm, especially in the range of 50 to 100 μm.

The photo-curable adhesive or transfer sheet of the invention obtained as above generally comprises the photo-curable composition containing the reactive polymer of a glass transition temperature of not more than 20° C. Further, the photo-curable adhesive or transfer sheet (generally corresponding to optical information recording substrate) generally has a light transmittance of not less than 70% in a wavelength rang of 380 to 420 nm, preferably 380 to 800 nm. In more detail, by setting the glass transition temperature of the reactive polymer to not more than 20° C., the resultant photo-curable sheet having flexibility can follow exactly the uneven surface of the stamper even at room temperature when the sheet is depressed on the stamper. Especially, in the case of the glass transition temperature of 15 to −50° C., the properties following exactly the uneven surface of the stamper is further improved. When the glass transition temperature is so high, high pressure and temperature is needed in the depressing or bonding operation whereby the workability is reduced. When the glass transition temperature is so low, the resultant sheet after curing does not have sufficient hardness.

As described above, the (cured) photo-curable adhesive or transfer sheet generally has a light transmittance of not less than 70% in a wavelength rang of 380 to 420 nm, preferably 380 to 800 nm, whereby reduction of the strength of signals to be read out with a laser beam can be prevented. Further, the sheet preferably has a light transmittance of not less than 80% in a wavelength rang of 380 to 420 nm.

The reactive polymer of the photo-curable composition preferably has 1 to 50% by mole of polymerizable functional group, whereby the cured photo-curable sheet has strength capable of holding its shape. The photopolymerization initiator is preferably used in the amount of 0.1 to 10% by weight as described previously. The amount of less than the lower limit causes workability to reduce owing to slow curing rate, whereas the amount of more than the upper limit causes the properties following exactly the uneven or rough surface of the stamper to reduce.

The photo-curable adhesive or transfer sheet of the invention can be offered as a film precisely controlled in the thickness, and therefore it is possible to easily and precisely bond the sheet to the uneven surface such as the substrate or stamper. This bonding (contact bonding) can be easily carried out by depressing the sheet and stamper by means of easy method using pressure rollers or easy press to temporarily bond them at temperature of 20 to 100° C., and then curing the sheet by exposing it to light at room temperature for one to tens seconds. Further, the temporarily bonded laminate is free from occurrence of slippage or peeling between of the sheet and stamper or substrate owing to its specific adhesion, and hence the laminate can be freely handled until the light-curing step.

In case the photo-curable adhesive or transfer sheet of the invention is cured, it is possible to adopt, as light source used, various sources generating light in the wavelength range of ultraviolet to visible rays. Examples of the sources include super-high-pressure, high-pressure and low-pressure mercury lamps, a chemical lamp, a xenon lamp, a halogen lamp, a mercury halogen lamp, a carbon arc lamp, and an incandescent electric lamp, and laser beam. The exposing time is generally in the range of a few seconds to a few minutes, depending upon kinds of the lamp and strength of light. To promote the curing, the laminate may be heated beforehand for 30 to 80° C., and then the heated laminate may be exposed to ultraviolet rays.

The metal reflective layer of the invention is formed on an uneven surface of the resultant cured photo-curable sheet having the uneven surface by metallizing (e.g., spattering, vacuum deposition, ion-plating). Examples of the metal materials include aluminum, gold, silver or alloy thereof. The semitransparent reflective layer provided on the sheet is generally formed by using silver as metal. In more detail, the semitransparent reflective layer is required to have low reflectivity compared with the reflective layer, and therefore is formed by changing the materials and/or the thickness.

When the organic polymer film is bonded onto the reflective layer of the cured sheet, an adhesive is applied onto one of the film and the sheet, and the other is superposed on the adhesive layer, which is cured. When the adhesive is UV-curable resin, it is cured by UV irradiation, and when the adhesive is hot-melt type, it is applied to the reflective layer under heating and then cooled.

In the preparation of the optical information recording medium of the invention, it is continuously processed in the form of sheet and finally punched out in the form of disc. However, it may be processed in the form of disc before the bonding.

### EXAMPLE

The invention is illustrated in detail using the following Examples.

### Example 1

<Preparation of Photo-Curable Adhesive Sheet>

(Preparation of Reactive Polymer)

Formulation I

| | | |
|---|---|---|
| 2-ethylhexyl methacrylate | 70 | parts by weight |
| methyl methacrylate | 20 | parts by weight |
| 2-hydroxyethyl methacrylate | 10 | parts by weight |
| benzophenone | 5 | parts by weight |
| toluene | 30 | parts by weight |
| ethyl acetate | 30 | parts by weight |

A mixture of the above Formulation I was heated to 60° C. with moderately stirring to initiate the polymerization, and stirred at this temperature for 10 hours to provide acrylic resin having a hydroxyl group on its side chain. Then, 5 parts by weight of Calens MOI (2-isocyanatoethyl methacrylate; available from Showa Denko K.K.) was added to the solution of the acrylic resin, and reacted with each other at 50° C. with moderately stirring to provide a solution 1 containing a reactive polymer having a photopolymerizable functional group.

The resultant reactive polymer has Tg of 0° C., weight-average molecular weight of 150,000 and 5% by mole of methacryloyl group on its side.

Formulation II

| | | |
|---|---|---|
| solution 1 of reactive polymer | 100 | parts by weight |
| tricyclodecane diacrylate | 30 | parts by weight |
| 1-hydroxycyclohexyl phenyl ketone | 1 | part by weight |

The above Formulation II was homogeneously dissolved to give a mixture, which was applied onto a release sheet (thickness: 75 μm; trade name: No. 23, available from Fujimori Kogyo) and dried to form a photo-curable adhesive sheet (layer) of thickness of 25±2 μm. Thus, the resultant photo-curable adhesive sheet had the release sheet and therefore the total thickness was 100±2 μm.

Preparation of One Optical Information Recording Substrate having Reflective Layer

A photo-curable transfer sheet was prepared in the same manner as in the photo-curable adhesive sheet. The resultant photo-curable transfer sheet having release sheet had thickness of 100 μm, which is thicker than the adhesive sheet.

The photo-curable transfer sheet was depressed on an unevenness surface of a stamper having the uneven surface as pits using a roller made of silicone rubber under load of 2 kg to form a laminate in which the shape of the uneven surface was transferred to a surface of the photo-curable transfer sheet.

Subsequently, the photo-curable transfer sheet of the laminate was exposed to UV-rays of a metal-halide lamp under the condition of an integrated amount of light of 1,000 mJ/cm² and as a result, the transferred layer (photo-curable sheet) was cured.

The stamper was peeled from the laminate. Silver alloy was spattered on the uneven surface of the cured photo-curable layer (optical information recording substrate) to form a semitransparent reflective layer of silver alloy. Thus, an optical information recording substrate having reflective layer was prepared.

Preparation of the Other Optical Information Recording Substrate having Reflective Layer

Melt carbonate was poured into a mold having an uneven surface as pits and solidified to form an optical information recording substrate having thickness of 1,100 μm. Aluminum was spattered on the uneven surface of the optical information recording substrate to form a reflective layer of Al. Thus, the other optical information recording substrate having reflective layer was prepared.

Preparation of Optical Information Recording Medium

The two optical information recording substrates prepared above were bonded to each other through the photo-curable adhesive sheet prepared above such that the two reflective layers faced each other to give a laminate, and the laminate was exposed to UV-rays of a metal-halide lamp under the condition of an integrated amount of light of 1,000 mJ/cm² and as a result, the photo-curable adhesive sheet was cured. Thus an optical information recording medium (DVD) was prepared.

### Example 2

<Preparation of Photo-Curable Adhesive Sheet>

(Preparation of Reactive Polymer)

Formulation I′

| | | |
|---|---|---|
| n-hexyl methacrylate | 50 | parts by weight |
| 2-hydroxyethyl methacrylate | 50 | parts by weight |
| benzophenone | 5 | parts by weight |
| toluene | 30 | parts by weight |
| ethyl acetate | 30 | parts by weight |

A mixture of the above Formulation I′ was heated to 60° C. with moderately stirring to initiate the polymerization, and stirred at this temperature for 10 hours to provide acrylic resin having a hydroxyl group on its side chain. Then, 50 parts by weight of Calens MOI (2-isocyanatoethyl methacrylate; available from Showa Denko K.K.) was added to the solution of the acrylic resin, and reacted with each other at 50° C. with moderately stirring to provide a solution 2 containing a reactive polymer having a photopolymerizable functional group.

The resultant reactive polymer has Tg of 5° C., weight-average molecular weight of 130,000 and 50% by mole of methacryloyl group on its side.

Formulation II′

| | | |
|---|---|---|
| solution 2 of reactive polymer | 100 | parts by weight |
| 1,6-hexanediol dimethacrylate | 10 | parts by weight |
| 1-hydroxycyclohexyl phenyl ketone | 1 | part by weight |

The above Formulation II′ was homogeneously dissolved to give a mixture, which was applied onto a release sheet (thickness: 75 μm; trade name: No. 23, available from Fujimori Kogyo) and dried to form a photo-curable adhesive sheet of thickness of 25±2 μm. Thus, the resultant photo-curable adhesive sheet had the release sheet and therefore the total thickness was 100±2 μm.

Preparation of One and the Other Optical Information Recording Substrates having Reflective Layer and Optical Information Recording Medium

One and the other optical information recording substrates and optical information recording medium were prepared in the same manner as described in Example 1 except for using the above photo-curable adhesive sheet. Thus DVD was obtained.

### Comparison Example 1

An optical information recording medium was prepared in the same manner as described in Example 1 except for performing the preparation of one optical information recording substrate and the recording medium in the following manner:

Preparation of One Optical Information Recording Substrate having Reflective Layer

Melt carbonate was poured into a mold having an uneven surface as pits and solidified to form an optical information recording substrate having thickness of 100±2 μm. Silver alloy was spattered on the uneven surface of the optical information recording substrate to form a semitransparent reflective layer of silver alloy. Thus, one optical information recording substrate having reflective layer was prepared.

Preparation of Optical Information Recording Medium

A liquid curable adhesive (SD-661; available from DAINIPPON INK AND CHEMICALS, INC.) which is commercially available was applied onto one of the two optical information recording substrates prepared above. The two optical information recording substrates were bonded to each other through the adhesive such that the two reflective layers faced each other to give a laminate, and the laminate was exposed to UV-rays whereby the adhesive sheet was cured. Thus an optical information recording medium (DVD) was prepared.

Evaluation of Optical Information Recording Substrate and Medium

(1) Light Transmittance (Wavelength of 380 to 800 nm)

Light transmittance of the resultant photo-curable adhesive sheet is measured in the wavelength of 380 to 800 nm according to JIS K6717. Light transmittance of 70% or more is marked as ◯, and Light transmittance of less than 70% is marked as X.

(2) Light Transmittance (wavelength of 380 to 420 nm)

Light transmittance of the resultant photo-curable adhesive sheet is measured in the wavelength of 380 to 420 nm according to JIS K6717. Light transmittance of 70% or more is marked as ◯, and Light transmittance of less than 70% is marked as X.

(3) Roughness of Land Portion

A land portion of an uneven surface on which pits were formed is evaluated on its smoothness using AFM (atomic force microscope). Land portion having sufficient smoothness is marked as ◯, and land portion having poor smoothness is marked as X.

(4) Readout of Signals

The information of the resultant optical information recording medium is read out using a laser beam of wavelength of 405 nm to obtain its wavy pattern. This wavy pattern is compared with that of the stamper. The wavy pattern of the medium coincident with that of the stamper is marked as ◯, and the wavy pattern of the medium little coincident with that of the stamper is marked as X.

The obtained results are shown in Table 1.

TABLE 1

| | Example 1 | Example 2 | Com. Example 1 |
|---|---|---|---|
| Light transmittance | ∘ | ∘ | ∘ |
| (380-800 nm) | | | |
| Light transmittance | ∘ | ∘ | ∘ |
| (380-420 nm) | | | |
| Roughness of land | ∘ | ∘ | x |
| Readout of signals | ∘ | ∘ | x |

As shown above, the photo-curable adhesive sheet according to the first aspect of the invention is depressed on an uneven shape of an optical information recording substrate to precisely follow the uneven surface and adhere to it. Thus the resultant optical information recording substrate has a signal surface (uneven surface) to which the adhesive layer (sheet) precisely adheres, and is free from adverse effect on the signal surface by the adhesion. Accordingly, the resultant optical information recording medium scarcely brings about occurrence of errors when the information (signals) is read out.

Further, in the adhesion procedure in the preparation of the optical information recording substrate of the invention, the photo-curable adhesive sheet used is softened and deformed and allowed to closely adhere to the uneven surface, and then cured. Therefore, optical information recording substrates can be bonded to each other by even a thin layer having a thickness of 300 μm or less. Further, the photo-curable adhesive sheet of the invention has high transparency compared with conventional UV curable resin, and furthermore has excellent dimensional stability due to less cure shrinkage than a conventional UV-curable resin. Hence, the resultant optical information recording medium prepared using the adhesive sheet does not suffer from deformation such as warpage.

For example, the photo-curable adhesive sheet of the invention has a small thickness (e.g., 25±2 μm, nonuniformity of ±2 μm) as an adhesive layer, and therefore the adhesive sheet shows excellent precision in the thickness compared with that of an adhesive layer formed by spin-coat-application of a conventional UV curable resin liquid, the application bringing about thickness-nonuniformity of ±5 μm. Such less thickness-nonuniformity can bring about enhancement of the dimensional stability.

Since the photo-curable adhesive sheet of the invention has the above excellent characteristics, it is apparent that the sheet is useful in not also the preparation of the resultant optical information recording medium but also the bonding operation in various fields.

### Example 3

<Preparation of Photo-Curable Tranfer Sheet>

(Preparation of Reactive Polymer)

Formulation I

| | | |
|---|---|---|
| 2-ethylhexyl methacrylate | 70 | parts by weight |
| methyl methacrylate | 20 | parts by weight |
| 2-hydroxyethyl methacrylate | 10 | parts by weight |
| benzophenone | 5 | parts by weight |
| toluene | 30 | parts by weight |
| ethyl acetate | 30 | parts by weight |

A mixture of the above Formulation I was heated to 60° C. with moderately stirring to initiate the polymerization, and stirred at this temperature for 10 hours to provide acrylic resin having a hydroxyl group on its side chain. Then, 5 parts by weight of Calens MOI (2-isocyanatoethyl methacrylate; available from Showa Denko K.K.) was added to the solution of the acrylic resin, and reacted with each other in an atmosphere of nitrogen at 50° C. with moderately stirring to provide a solution 1 containing a reactive polymer having a photopolymerizable functional group.

The resultant reactive polymer has Tg of 0° C., weight-average molecular weight of 150,000 and 5% by mole of methacryloyl group on its side.

Formulation II

| | | |
|---|---|---|
| solution 1 of reactive polymer | 100 | parts by weight |
| tricyclodecane diacrylate | 30 | parts by weight |
| 1-hydroxycyclohexyl phenyl ketone | 1 | part by weight |

The above Formulation II was homogeneously dissolved to give a mixture, which was applied onto a release sheet (thickness: 75 μm; trade name: No. 23, available from Fujimori Kogyo) and dried to form a photo-curable transfer sheet of thickness of 25±2 μm. Further, the above release sheet was bonded onto a reverse side of the photo-curable transfer sheet having release sheet.

Preparation of Optical Information Recording Medium

One of the release sheets of the photo-curable transfer sheet was removed. The photo-curable transfer sheet was disposed on an Al reflective layer (thickness: 70 nm) formed on an unevenness surface of a polycarbonate substrate (thickness: 1.1 mm) having the uneven surface as pits such that the surface having no release sheet faced the Al reflective layer, and the photo-curable transfer sheet was depressed on the polycarbonate substrate using a roller made of silicone rubber under load of 2 kg to form a laminate (corresponding to the step of (2) in FIG. 6).

The other release sheet was removed from the resultant laminate. A stamper made of nickel and having an uneven surface as pits was disposed on an exposed surface of the transfer sheet of the laminate such that the uneven surface faced the exposed surface, and then the stamper was depressed on the laminate using a roller made of silicone rubber under load of 2 kg to form a laminate, whereby the uneven surface of the stamper was transferred to the surface of the transfer sheet.

Subsequently, the photo-curable transfer sheet of the laminate provided with the stamper was exposed to UV-rays of a metal-halide lamp under the condition of an integrated amount of light of 1,000 mJ/cm² and as a result, the transferred photo-curable sheet was cured.

The stamper was removed from the laminate. Silver alloy was spattered on the uneven surface of the cured photo-curable transfer sheet to form a semitransparent reflective layer of silver alloy. A polycarbonate film (thickness: 70 μm; Pure Ace C110-70, available from TEIJIN LTD.) was contact bonded to the semitransparent reflective layer through an adhesive.

Thus, an optical information recording medium having two uneven surfaces was prepared.

### Example 4

<Preparation of Photo-Curable Tranfer Sheet>

(Preparation of Reactive Polymer)

Formulation I′

| | | |
|---|---|---|
| n-hexyl methacrylate | 50 | parts by weight |
| 2-hydroxyethyl methacrylate | 50 | parts by weight |
| benzophenone | 5 | parts by weight |
| toluene | 30 | parts by weight |
| ethyl acetate | 30 | parts by weight |

A mixture of the above Formulation I′ was heated to 60° C. with moderately stirring to initiate the polymerization, and stirred at this temperature for 10 hours to provide acrylic resin having a hydroxyl group on its side chain. Then, 50 parts by weight of Carends MOI (2-isocyanatoethyl methacrylate; available from Showa Denko K.K.) was added to the solution of the acrylic resin, and reacted with each other in an atmosphere of nitrogen at 50° C. with moderately stirring to provide a solution 2 containing a reactive polymer having a photopolymerizable functional group.

The resultant reactive polymer has Tg of 5° C., weight-average molecular weight of 130,000 and 50% by mole of methacryloyl group on its side.

Formulation II′

| | | |
|---|---|---|
| solution 2 of reactive polymer | 100 | parts by weight |
| 1,6-hexanediol dimethacrylate | 10 | parts by weight |
| 1-hydroxycyclohexyl phenyl ketone | 1 | part by weight |

An above Formulation II′ was uniformly dissolved to give a mixture, which was applied onto a film of Pure Ace C110-70 (thickness: 70 μm; available from TEIJIN LTD.) and dried to form a photo-curable transfer sheet of thickness of 30±2 μm. Thus, the resultant photo-curable adhesive sheet had the release sheet and therefore the total thickness was 100±2 μm.

Preparation of Optical Information Recording Medium

DVD was obtained in the same manner in Example 3 except for using the above photo-curable transfer sheet having the film.

### Comparison Example 2

Preparation of Optical Information Recording Medium

A liquid UV-curable adhesive (SD-661; available from DAINIPPON INK AND CHEMICALS, INC.) was applied onto disposed on an Al reflective layer (thickness: 70 nm) formed on an unevenness surface of a polycarbonate substrate (thickness: 1.1 mm) having the uneven surface as pits, whereby a UV-curable resin layer A having a thickness of 10 μm was formed.

A liquid UV curable adhesive (SD-661; available from DAINIPPON INK AND CHEMICALS, INC.) was applied onto disposed on an unevenness surface of a stamper having the uneven surface as pits, whereby a UV curable resin layer B having a thickness of 10 μm was formed.

The resultant substrate and the stamper were laminated on each other such that the UV curable resin layers A and B faced each other to provide a laminate.

Subsequently, the UV curable resin layers A and B of the laminate were exposed to UV-rays of a metal-halide lamp under the condition of an integrated amount of light of 2,000 mJ/cm² and as a result, the resin layers were cured.

The stamper was removed from the laminate. Silver alloy was spattered on the uneven surface of the cured UV curable resin layers B to form a semitransparent reflective layer of silver alloy. A polycarbonate film (thickness: 70 μm; Pure Ace C110-70, available from TEIJIN LTD.) was bonded to the semitransparent reflective layer through an adhesive.

Thus, an optical information recording medium having two uneven surfaces was prepared.

Evaluation of Optical Information Recording Substrate and Medium

(1) Light Transmittance (Wavelength of 380 to 420 nm)

Light transmittance of one optical information recording substrate is measured in the wavelength of 380 to 420 nm according to JIS K6717. Light transmittance of 80% or more is marked as ◯, and Light transmittance of less than 80% is marked as X.

(2) Roughness of Land Portion

A land portion of a uneven surface on which pits were formed is evaluated on its smoothness using AFM (atomic force microscope). Land portion having sufficient smoothness is marked as ◯, and land portion having poor smoothness is marked as X.

(3) Readout of Signals

The information of the resultant optical information recording medium is read out using a laser beam of wavelength of 405 nm to obtain its wavy pattern. This wavy pattern is compared with that of the stamper. The wavy pattern of the medium coincident with that of the stamper is marked as ◯, and the wavy pattern of the medium little coincident with that of the stamper is marked as X.

The obtained results are shown in Table 2.

TABLE 2

| | Example 3 | Example 4 | Com. Example 2 |
|---|---|---|---|
| Light transmittance | ∘ | ∘ | ∘ |
| (380-420 nm) | | | |
| Roughness of land | ∘ | ∘ | x |
| Readout of signals | ∘ | ∘ | x |

The optical information recording medium obtained in Comparison Example 2 has disadvantages of difficultly removing bubbles generated during the laminating step, and of having poor transparency and increased warpage, compared with the media obtained in Examples 3 and 4. Therefore the medium of Comparison Example 2 is considered to be poor in the evaluated characteristics.

As described above, by the process for the preparation of the photo-curable transfer sheet according to the second aspect of the invention, a further layer having an uneven surface can be formed extremely easily and in high productivity on an uneven surface of a disc substrate. Further, the process of the invention permits an uneven surface of a disc substrate or a stamper to be easily and precisely transferred to the transfer sheet without generation of bubbles. Thus the resultant optical information recording substrate or medium has a signal surface (uneven surface) to which an uneven shape of a stamper or substrate is precisely transferred. Accordingly, an optical information recording medium prepared from the process scarcely brings about occurrence of error when the information (signals) is read out.

Moreover, the process of the invention makes it possible to easily and precisely cover an uneven surface of a disc substrate. Further, the photo-curable transfer sheet used in the process of the invention has excellent dimension stability due to reduced shrinkage compared with a conventional UV-curable resin, and hence the process provides an optical information recording medium free from deformation such as warpage.

### Example 5

<Preparation of Photo-Curable Transfer Sheet>

(Preparation of Reactive Polymer)

Formulation I

| | | |
|---|---|---|
| 2-ethylhexyl methacrylate | 70 | parts by weight |
| methyl methacrylate | 20 | parts by weight |
| 2-hydroxyethyl methacrylate | 10 | parts by weight |
| benzophenone | 5 | parts by weight |
| toluene | 30 | parts by weight |
| ethyl acetate | 30 | parts by weight |

A mixture of the above Formulation I was heated to 60° C. with moderately stirring to initiate the polymerization, and stirred at this temperature for 10 hours to provide acrylic resin having a hydroxyl group on its side chain. Then, 5 parts by weight of Calens MOI (2-isocyanatoethyl methacrylate; available from Showa Denko K.K.) was added to the solution of the acrylic resin, and reacted with each other at 50° C. with moderately stirring to provide a solution 1 containing a reactive polymer having a photopolymerizable functional group.

The resultant reactive polymer has Tg of 0° C., weight-average molecular weight of 150,000 and 5% by mole of methacryloyl group on its side.

Formulation II

| | | |
|---|---|---|
| solution 1 of reactive polymer | 100 | parts by weight |
| tricyclodecane diacrylate | 30 | parts by weight |
| 1-hydroxycyclohexyl phenyl ketone | 1 | part by weight |

The above Formulation II was homogeneously dissolved to give a mixture, which was applied onto a release sheet (surface roughness Ra=20 nm, available from Fujimori Kogyo) and dried. Thus, a photo-curable adhesive sheet having release sheet (surface roughness Ra=20 nm) of thickness of 100±2 μm was prepared.

Preparation of One Optical Information Recording Substrate having Reflective Layer

The photo-curable transfer sheet was depressed on an unevenness surface of a stamper made of nickel having the uneven surface as pits using a roller made of silicone rubber under load of 2 kg to form a laminate in which the shape of the uneven surface was transferred to a surface of the photo-curable transfer sheet.

Subsequently, the photo-curable transfer sheet of the laminate was exposed to UV-rays of a metal-halide lamp under the condition of an integrated amount of light of 2,000 mJ/cm² and as a result, the transferred layer (photo-curable sheet) was cured.

The stamper was peeled from the laminate. Silver alloy was spattered on the uneven surface of the cured photo-curable layer (optical information recording substrate) to form a semitransparent reflective layer of silver alloy. Thus, an optical information recording substrate having reflective layer was prepared.

Preparation of the Other Optical Information Recording Substrate having Reflective Layer

Melt carbonate was poured into a mold having an uneven surface as pits and solidified to form an optical information recording substrate having thickness of 1,100 μm. Aluminum was spattered on the uneven surface of the optical information recording substrate to form a reflective layer of Al. Thus, the other optical information recording substrate having reflective layer was prepared.

Preparation of Optical Information Recording Medium

A liquid photo-curable adhesive (SD-661; available from DAINIPPON INK AND CHEMICALS, INC.), which is commercially available, was applied onto one of the two optical information recording substrates prepared above by spin coating. The two optical information recording substrates were bonded to each other through the adhesive such that the two reflective layers faced each other to give a laminate, and the laminate was exposed to UV-rays whereby the adhesive was cured. Thus an optical information recording medium (DVD; surface roughness Ra=20 nm) was prepared.

### Example 6

<Preparation of Photo-Curable Adhesive Sheet>

(Preparation of Reactive Polymer)

Formulation I′

| | | |
|---|---|---|
| n-hexyl methacrylate | 50 | parts by weight |
| 2-hydroxyethyl methacrylate | 50 | parts by weight |
| benzophenone | 5 | parts by weight |
| toluene | 30 | parts by weight |
| ethyl acetate | 30 | parts by weight |

A mixture of the above Formulation I′ was heated to 60° C. with moderately stirring to initiate the polymerization, and stirred at this temperature for 10 hours to provide acrylic resin having a hydroxyl group on its side chain. Then, 50 parts by weight of Calens MOI (2-isocyanatoethyl methacrylate; available from Showa Denko K.K.) was added to the solution of the acrylic resin, and reacted with each other at 50° C. with moderately stirring to provide a solution 2 containing a reactive polymer having a photopolymerizable functional group.

The resultant reactive polymer has Tg of 5C, weight-average molecular weight of 130,000 and 50% by mole of methacryloyl group on its side.

Formulation II′

| | | |
|---|---|---|
| solution 2 of reactive polymer | 100 | parts by weight |
| 1,6-hexanediol dimethacrylate | 10 | parts by weight |
| 1-hydroxycyclohexyl phenyl ketone | 1 | part by weight |

The above Formulation II′ was homogeneously dissolved to give a mixture, which was applied onto a release sheet (surface roughness Ra=2 nm, thickness: 70 μm; trade name: Pure Ace C110-70, available from TEIJIN LTD.) and dried. Thus, a photo-curable adhesive sheet (surface roughness Ra=2 nm) having thickness of 100±2 μm was prepared.

Preparation of Optical Information Recording Medium

One and the other optical information recording substrates having reflective layer and an optical information recording medium were prepared in the same manner as Example 5 by using the resultant transfer sheet. Thus an optical information recording medium (DVD; surface roughness Ra=2 nm) was prepared.

### Comparison Example 3

The above Formulation I obtained in Example 5 was homogeneously dissolved to give a mixture, which was applied onto a release sheet made of polyester (surface roughness Ra=33 nm, thickness: 70 μm; available from TEIJIN LTD.) and dried. Thus, a photo-curable adhesive sheet having release sheet (surface roughness Ra=33 nm) of thickness of 100±2 μm was prepared.

Subsequently, one and the other optical information recording substrates having reflective layer and an optical information recording medium were prepared in the same manner as Example 5 by using the resultant transfer sheet. Thus an optical information recording medium (DVD; surface roughness Ra=33 nm) was prepared.

### Example 7

On the exposed surface (reproduction side) of the optical information recording medium obtained in Comparison Example 3, a hard-coat liquid solution (Seikabeam VDAL292, available from) was applied by spin coating, and exposed to UV. Thus an optical information recording medium was prepared.

The surface roughness (Ra: center-line average roughness) of each of Examples 5 to 7 and Comparison Examples 3 was determined below.

Measuring method of surface roughness:

Ra (center-line average roughness) of the sheet was measured by using a contact-type surface-roughness instrument (Talystep; available from Taylor Hobson).

Evaluation of Optical Information Recording Substrate and Medium

(1) Light Transmittance (Wavelength of 380 to 420 nm)

Light transmittance of the resultant photo-curable adhesive sheet is measured in the wavelength of 380 to 420 nm according to JIS K6717. Light transmittance of 70% or more is marked as ◯, and Light transmittance of less than 70% is marked as X.

(2) Roughness of Land Portion

A land portion of an uneven surface on which pits were formed is evaluated on its smoothness using AFM (atomic force microscope). Land portion having sufficient smoothness is marked as ◯, and land portion having poor smoothness is marked as X.

(3) Readout of Signals

The information of the resultant optical information recording medium is read out using a laser beam of wavelength of 405 nm to obtain its wavy pattern. This wavy pattern is compared with that of the stamper. The wavy pattern of the medium coincident with that of the stamper is marked as ◯, and the wavy pattern of the medium little coincident with that of the stamper is marked as X.

The obtained results are shown in Table 3.

TABLE 3

| | Example 5 | Example 6 | Example 7 | Co. Example 3 |
|---|---|---|---|---|
| Light transmittance | ∘ | ∘ | ∘ | ∘ |
| (380-420 nm) | | | | |
| Roughness of land | ∘ | ∘ | ∘ | ∘ |
| Readout of signals | ∘ | ∘ | ∘ | x |

As shown above, the photo-curable transfer sheet according to the third aspect of the invention is depressed on an uneven shape of a stamper for preparing an optical information recording substrate to precisely follow the uneven surface, and therefore the uneven surface is precisely transferred to the surface of the transfer sheet, and simultaneously the adhesive sheet has an extremely smooth reverse surface having no unevenness. Thus the resultant optical information recording medium or substrate has a signal surface (uneven surface) to which the unevenness of the stamper has be precisely transferred and an extremely smooth reverse side (surface) corresponding to a laser-irradiation-side. Accordingly, the resultant optical information recording medium scarcely brings about occurrence of errors when the information (signals) is recorded or read out.

Further, the optical information recording medium or substrate obtained by the invention is formed by deforming the photo-curable transfer sheet by melting and curing it to form an uneven surface, and therefore even the optical information recording substrate having a thickness of 300 μm or less can be prepared with excellent transferring.

Description of Reference Number
11: Photo-curable adhesive sheet
12a, 12b: Release sheet
23: Reflective layer
21, 24: Optical information recording substrate
25: Semitransparent reflective layer
51: Photo-curable transfer sheet
52a, 52b: Release sheet
61: Substrate
63: Reflective layer
64: Stamper
65: Silver alloy reflective layer (Semitransparent reflective layer)
66: Organic polymer film (cover layer)
81: Photo-curable transfer sheet
82a, 82b: Release sheet
82c: Support
83: Silver alloy reflective layer
90: Photo-curable transfer sheet having unevenness (optical information recording substrate)
91: Stamper
100: Optical information recording substrate
110: Optical information recording medium
1, 2: Transparent resin substrate
1a, 2a: Reflective layer
3: Adhesive layer
1b: Semitransparent layer

1. A photo-curable adhesive sheet comprising a photo-curable composition which comprises a reactive polymer having a photopolymerizable functional group and weight-average molecular weight of not less than 5,000 and which has a glass transition temperature of not more than 20° C., the photo-curable adhesive sheet having a light transmittance of not less than 70% in a wavelength range of 380 to 420 nm.

2. The photo-curable adhesive sheet as defined in claim 1, wherein the reactive polymer has a glass transition temperature of not more than 20° C.

3. The photo-curable adhesive sheet as defined in claim 1, which has a light transmittance of not less than 80% in a wavelength rang of 380 to 420 nm.

4. The photo-curable adhesive sheet as defined in claim 1, wherein the reactive polymer is an acrylic resin.

5. The photo-curable adhesive sheet as defined in claim 1, wherein the reactive polymer has 1 to 50% by mole of the photopolymerizable functional group.

6. The photo-curable adhesive sheet as defined in claim 1, wherein the photopolymerizable functional group is a (meth)acryloyl group.

7. The photo-curable adhesive sheet as defined in claim 1, wherein the photo-curable composition contains 0.1 to 10% by weight of a photopolymerization initiator.

8. The photo-curable adhesive sheet as defined in claim 1, which has a thickness of 5 to 300 μm.

9. The photo-curable adhesive sheet as defined in claim 1, wherein a release sheet is provided on at least one side of the photo-curable adhesive sheet.

10. A process for the preparation of an optical information recording medium comprising:
superposing two optical information recording substrates having an uneven surface of recorded pits and/or grooves on each other through the photo-curable adhesive sheet as defined in claim 1 such that the two uneven surfaces face each other,
depressing the substrates and the adhesive sheet to form a laminate, and
curing the laminate by light.

11. The process as defined in claim 10, wherein the depressing step is carried out under reduced pressure.

12. The process as defined in claim 10 or 11, wherein the depressing step is carried out at room temperature.

13. A process for the preparation of an optical information recording medium comprising:
placing a photo-curable transfer sheet comprising a photo-curable composition which comprises a reactive polymer having a photopolymerizable functional group and weight-average molecular weight of not less than 5,000 and which is capable of deforming by application of pressure on an optical information recording substrate having an uneven surface of recorded pits and/or grooves such that one side of the photo-curable transfer sheet is in contact with the uneven surface of the optical information recording substrate,
depressing the sheet and substrate to form a laminate in which the one side of the photo-curable transfer sheet adheres closely to the uneven surface, and
exposing the photo-curable transfer sheet of the laminate to ultraviolet rays to cure the transfer sheet.

14. The process as defined in claim 13, the depressing step is carried out under reduced pressure.

15. The process as defined in claim 13 or 14, wherein a reflective layer is provided on the uneven surface of the optical information recording substrate.

16. A process for the preparation of an optical information recording medium comprising:
placing a photo-curable transfer sheet comprising a photo-curable composition which comprises a reactive polymer having a photopolymerizable functional group and weight-average molecular weight of not less than 5,000 and which is capable of deforming by application of pressure on an optical information recording substrate having an uneven surface of recorded pits and/or grooves such that one side of the photo-curable transfer sheet is in contact with the uneven surface of the optical information recording substrate,
depressing the transfer sheet and the substrate to allow the one side of the photo-curable transfer sheet to adhere closely to the uneven surface,
placing a stamper having an uneven surface of recorded pits and/or grooves on the photo-curable transfer sheet such that the uneven surface of the stamper is in contact with a side having no contact with the substrate of the photo-curable transfer sheet,
depressing the substrate, the transfer sheet and the stamper to form a laminate in which the side of the photo-curable transfer sheet adheres closely to the uneven surface of the stamper,
exposing the photo-curable transfer sheet of the laminate to ultraviolet rays to cure the transfer sheet, and
removing the stamper out of the laminate to form unevenness on a surface of the cured photo-curable transfer sheet.

17. The process as defined in claim 16, wherein an organic polymer film is further provided on the surface having unevenness of the cured photo-curable transfer sheet through an adhesive layer.

18. The process as defined in claim 16, wherein another photo-curable transfer sheet is further depressed on the surface having unevenness of the cured photo-curable transfer sheet and cured by irradiation of ultraviolet light.

19. The process as defined in claim 16, wherein the depressing step is carried out under reduced pressure.

20. The process as defined in claim 16, wherein a reflective layer has been provided on the unevenness surface of the substrate, and a semitransparent reflective layer is further provided on the surface having unevenness of the cured photo-curable transfer sheet.

21. The process as defined in claim 13, wherein the photo-curable composition has a glass transition temperature of not more than 20° C.

22. The process as defined in claim 13, wherein the photo-curable transfer sheet has a light transmittance of not less than 70% in a wavelength range of 380 to 420 nm.

23. The process as defined in claim 13, wherein the photo-curable transfer sheet has a thickness of 5 to 300 μm.

24. An optical information recording medium prepared by the process as defined in claim 13 any of claims 13.

25. A photo-curable transfer sheet comprising a photo-curable composition which comprises a reactive polymer having a photopolymerizable functional group and weight-average molecular weight of not less than 5,000 and which is capable of deforming by application of pressure, at least one side of the photo-curable transfer sheet having a surface roughness (Ra) of not more than 30 nm.

26. The photo-curable transfer sheet as defined in claim 25, wherein the reactive polymer has a glass transition temperature of not more than 20° C.

27. The photo-curable transfer sheet as defined in claim 25 or 26, wherein the surface roughness (Ra) of not more than 10 nm.

28. The photo-curable transfer sheet as defined in claim 25, which has a light transmittance of not less than 70% in a wavelength range of 380 to 420 nm.

29. The photo-curable transfer sheet as defined in claim 25, which has a thickness of 5 to 300 μm.

30. A process for the preparation of a photo-curable transfer sheet as defined in claim 25 comprising:
melting a photo-curable composition which comprises a reactive polymer having a photopolymerizable functional group and weight-average molecular weight of not less than 5,000 and which is capable of deforming by application of pressure, and
casting the melted composition onto an surface of a support having a surface roughness (Ra) of not more than 30 nm.

31. A process for the preparation of a photo-curable transfer sheet as defined in claim 25 comprising:
applying a coating liquid containing a photo-curable composition which comprises a reactive polymer having a photopolymerizable functional group and weight-average molecular weight of not less than 5,000 and which is capable of deforming by application of pressure onto a surface of a support having a surface roughness (Ra) of not more than 30 nm, and
drying a layer of the coating liquid.
